(19) United States
(12) Patent Application Publication
(10) Pub. No.: US 2025/0265485 A1
(43) Pub. Date: Aug. 21, 2025

(54) TOPOLOGICAL ERROR CORRECTION

(71) Applicant: Classiq Technologies LTD., Tel Aviv (IL)

(72) Inventors: Amir Naveh, Haifa (IL); Shmuel Ur, Shorashim (IL); Gilad Kishony, Haifa (IL); Eyal Cornfeld, Ramat Gan (IL); Yehuda Naveh, Tel-Aviv Yafo (IL)

(21) Appl. No.: 18/444,281

(22) Filed: Feb. 16, 2024

(51) Int. Cl. G06N 10/40; G06N 10/70

(52) U.S. Cl. CPC G06N 10/40; G06N 10/70

(57) ABSTRACT

A method, product, and apparatus comprising: obtaining a logical representation of a quantum circuit that defines a plurality of gate operations on subsets of a plurality of logical qubits; obtaining a physical representation of the quantum circuit on a quantum computer comprising a set of physical qubits positioned on a plane embedded in at least two dimensions, the physical representation comprising: a division of the set of physical qubits into a plurality of patches, the plurality of patches comprising qubit patches and auxiliary patches; and a mapping of the plurality of logical qubits to the qubit patches; allocating the plurality of gate operations to a set of layers, whereby determining a reduced number of layers for the quantum circuit; and synthesizing the quantum circuit according to the set of layers.

### TECHNICAL FIELD

The present disclosure relates to quantum computing in general, and to topological error correction in quantum computing, in particular.

### BACKGROUND

Quantum computing is a computational paradigm that is fundamentally different from classic computing. In contrast to classic computing, which utilizes bits, quantum computing utilizes qubits. The qubits have unique features, as each qubit can be in superposition, several qubits can be entangled, and all operations on qubits besides measurement (referred to as quantum gates) must be reversible.

Quantum Error Correction (QEC) may be configured to protect quantum information from errors due to decoherence and other quantum noise. Quantum error correction is essential for reducing noise of stored quantum information.

### BRIEF SUMMARY

One exemplary embodiment of the disclosed subject matter is a method comprising: obtaining a logical representation of a quantum circuit, wherein the logical representation comprises a plurality of logical qubits, wherein the logical representation defines a plurality of gate operations on subsets of the plurality of logical qubits; obtaining a physical representation of the quantum circuit on a quantum computer, the quantum computer comprising a set of physical qubits positioned on a plane embedded in at least two dimensions, the physical representation comprising: a division of the set of physical qubits into a plurality of patches, the plurality of patches comprising a plurality of qubit patches and one or more auxiliary patches, wherein no qubit in the set of physical qubits belongs to more than one patch of the plurality of patches; and a mapping of the plurality of logical qubits to the plurality of qubit patches; allocating the plurality of gate operations to a set of layers, whereby determining a reduced number of layers for the quantum circuit, wherein said allocating is performed based on the physical representation and based on an optimization function, wherein the optimization function is configured to minimize a number of the set of layers while complying with layer collision constraints, the plurality of gate operations comprises at least a first gate operation, a second gate operation and a third gate operation, the set of layers comprises at least a first layer, a second layer and a third layer, whereby said allocating comprises designating the first gate operation to the first layer, designating the second gate operation to the second layer, and designating the third gate operation to the third layer, wherein the logical representation indicates that the first gate operation is applied on first and second logical qubits of the plurality of logical qubits, wherein said allocating comprises determining a qubit route between first and second qubit patches of the plurality of qubit patches, the first and second qubit patches representing the first and second logical qubits, respectively, wherein said allocating comprises designating the qubit route to the first layer; and synthesizing the quantum circuit according to the set of layers, whereby a synthesized quantum circuit is optimized according to the optimization function.

Optionally, the layer collision constraints define that qubit routes for implementing the plurality of gate operations between the plurality of patches cannot collide within a same layer, whereby the qubit route does not collide with any other qubit route within the first layer.

Optionally, said obtaining the physical representation comprises generating the physical representation based on precedence constraints of the logical representation and based on the optimization function.

Optionally, said generating the physical representation comprises selecting, for each logical qubit of the plurality of logical qubits, a patch from the plurality of qubit patches for representing the each logical qubit.

Optionally, said generating the physical representation comprises selecting for the first and second logical qubits a single patch from the plurality of qubit patches for representing the first and second logical qubits.

Optionally, said generating the physical representation comprises determining, for each logical qubit of the plurality of logical qubits, properties of a respective qubit patch from the plurality of qubit patches, the properties comprising at least one of: a size, a relative location in the plane, and a shape of the patch within the plane.

Optionally, said generating the physical representation comprises determining to dynamically adjust a property at least one patch from the plurality of patches during an execution of the synthesized quantum circuit on the quantum computer.

Optionally, the property comprising at least one of: a size of the at least one patch, a relative location of the at least one patch in the plane, and a shape of the at least one patch within the plane.

Optionally, the property comprises the size of the at least one patch, wherein the size of the at least one patch is selected such that a number of physical qubits that constitute the at least one patch is greater than a number of the logical qubits represented by the at least one patch.

Optionally, said dynamically adjusting the property of the at least one patch comprises: determining that gate operations are applied on the first and second qubit patches a plurality of times within one or more layers that are subsequent to an intermediate layer of the plurality of layers; determining that the qubit path between the first and second qubit patches is longer than a threshold; and determining to dynamically adjust a relative location of the second qubit patch in the plane to a second relative location in the plane that is adjacent to the first qubit patch after the intermediate layer.

Optionally, said generating the physical representation comprises determining, for each gate operation of the plurality of gate operations that is configured to be applied on the first and second logical qubits, a respective qubit route between the first and second qubit patches.

Optionally, said generating the physical representation comprises selecting one or more relative locations in the plane and qubit routes for one or more respective T factory patches in the physical representation, wherein the plurality of patches comprises the T factory patches.

Optionally, the logical representation of the quantum circuit is implementable by a plurality of alternative physical representations of the quantum circuit, each of which implementing the logical representation in a different way, wherein said generating the physical representation comprises selecting the physical representation for the quantum circuit from the plurality of alternative physical representations based on the optimization function.

Optionally, the qubit route comprises qubits from the one or more auxiliary patches that physically connect the first and second qubit patches.

Optionally, the physical representation utilizes a surface code technique for representing the plurality of logical qubits using the plurality of qubit patches and for representing the plurality of gate operations using the one or more auxiliary patches, whereby errors of qubits in the plurality of patches are iteratively corrected every error correction layer of the surface code technique.

Optionally, the optimization function is configured to reduce at least one of: an overall error rate of the quantum circuit, a runtime of the quantum circuit, and a total number of physical qubits that is allocated to the physical representation.

Optionally, the logical representation of the quantum circuit is configured to provide an output via one or more logical output qubits, wherein the overall error rate of the quantum circuit comprises an error rate of the one or more logical output qubits.

Optionally, the optimization function defines a Constraint Satisfaction Problem (CSP) that corresponds to the quantum circuit, the CSP comprises variables, domains and constraints, each variable of the variables has a corresponding domain in the domains that defines one or more potential values of the variable, the constraints define one or more constraints on values of the variables or portion thereof, the constraints comprise the layer collision constraints, precedence constraints between the plurality of gate operations, collision constraints on qubit routes of a same layer, surface code constraints, and hardware constraints associated with the plane of at least two dimensions; and the method further comprises generating the physical representation by utilizing a CSP solver to solve the CSP, wherein a solution of the CSP defines the physical representation of the quantum circuit.

Optionally, the CSP further comprise parameters defining: borders and relative locations of the plurality of qubit patches within the plane, borders and relative locations of the one or more auxiliary patches within the plane, and a mapping of the plurality of logical qubits to the plurality of patches.

Optionally, the plurality of qubit patches is configured to represent the plurality of logical qubits, wherein the one or more auxiliary patches are configured to represent an auxiliary region for applying the plurality of gate operations between at least a subset of the plurality of qubit patches, the auxiliary region comprising qubit routes between the subset of the plurality of qubit patches.

Optionally, the logical representation of the quantum circuit comprises a Directed Acyclic Graph (DAG), wherein nodes of the DAG represent the plurality of gate operations, wherein edges between the nodes represent precedence constraints between the plurality of gate operations.

Optionally, the plane of at least two dimensions comprises a mapping of physical connectivity links between each two physical qubits of the set of physical qubits, wherein the each two physical qubits of the set of physical qubits are either connected or not connected.

Optionally, the plurality of patches comprises a respective plurality of groups of physical qubits from the set of physical qubits, wherein each group of the plurality of groups comprises connected physical qubits, wherein no patch of the plurality of patches comprises a physical qubit that is not physically connected to any other physical qubit in the patch.

Another exemplary embodiment of the disclosed subject matter is an apparatus comprising a processor and coupled memory, said processor being adapted to: obtain a logical representation of a quantum circuit, wherein the logical representation comprises a plurality of logical qubits, wherein the logical representation defines a plurality of gate operations on subsets of the plurality of logical qubits; obtain a physical representation of the quantum circuit on a quantum computer, the quantum computer comprising a set of physical qubits positioned on a plane embedded in at least two dimensions, the physical representation comprising: a division of the set of physical qubits into a plurality of patches, the plurality of patches comprising a plurality of qubit patches and one or more auxiliary patches, wherein no qubit in the set of physical qubits belongs to more than one patch of the plurality of patches; and a mapping of the plurality of logical qubits to the plurality of qubit patches; allocate the plurality of gate operations to a set of layers, whereby determining a reduced number of layers for the quantum circuit, wherein said allocate is performed based on the physical representation and based on an optimization function, wherein the optimization function is configured to minimize a number of the set of layers while complying with layer collision constraints, the plurality of gate operations comprises at least a first gate operation, a second gate operation and a third gate operation, the set of layers comprises at least a first layer, a second layer and a third layer, whereby said allocate comprises designating the first gate operation to the first layer, designating the second gate operation to the second layer, and designating the third gate operation to the third layer, wherein the logical representation indicates that the first gate operation is applied on first and second logical qubits of the plurality of logical qubits, wherein said allocate comprises determining a qubit route between first and second qubit patches of the plurality of qubit patches, the first and second qubit patches representing the first and second logical qubits, respectively, wherein said allocate comprises designating the qubit route to the first layer; and synthesize the quantum circuit according to the set of layers, whereby a synthesized quantum circuit is optimized according to the optimization function.

Yet another exemplary embodiment of the disclosed subject matter is a system comprising a processor and coupled memory, said processor being adapted to: obtain a logical representation of a quantum circuit, wherein the logical representation comprises a plurality of logical qubits, wherein the logical representation defines a plurality of gate operations on subsets of the plurality of logical qubits; obtain a physical representation of the quantum circuit on a quantum computer, the quantum computer comprising a set of physical qubits positioned on a plane embedded in at least two dimensions, the physical representation comprising: a division of the set of physical qubits into a plurality of patches, the plurality of patches comprising a plurality of qubit patches and one or more auxiliary patches, wherein no qubit in the set of physical qubits belongs to more than one patch of the plurality of patches; and a mapping of the plurality of logical qubits to the plurality of qubit patches; allocate the plurality of gate operations to a set of layers, whereby determining a reduced number of layers for the quantum circuit, wherein said allocate is performed based on the physical representation and based on an optimization function, wherein the optimization function is configured to minimize a number of the set of layers while complying with layer collision constraints, the plurality of gate operations comprises at least a first gate operation, a second gate operation and a third gate operation, the set of layers comprises at least a first layer, a second layer and a third layer, whereby said allocate comprises designating the first gate operation to the first layer, designating the second gate operation to the second layer, and designating the third gate operation to the third layer, wherein the logical representation indicates that the first gate operation is applied on first and second logical qubits of the plurality of logical qubits, wherein said allocate comprises determining a qubit route between first and second qubit patches of the plurality of qubit patches, the first and second qubit patches representing the first and second logical qubits, respectively, wherein said allocate comprises designating the qubit route to the first layer; and synthesize the quantum circuit according to the set of layers, whereby a synthesized quantum circuit is optimized according to the optimization function.

Yet another exemplary embodiment of the disclosed subject matter is a computer program product comprising a non-transitory computer readable medium retaining program instructions, which program instructions when read by a processor, cause the processor to: obtain a logical representation of a quantum circuit, wherein the logical representation comprises a plurality of logical qubits, wherein the logical representation defines a plurality of gate operations on subsets of the plurality of logical qubits; obtain a physical representation of the quantum circuit on a quantum computer, the quantum computer comprising a set of physical qubits positioned on a plane embedded in at least two dimensions, the physical representation comprising: a division of the set of physical qubits into a plurality of patches, the plurality of patches comprising a plurality of qubit patches and one or more auxiliary patches, wherein no qubit in the set of physical qubits belongs to more than one patch of the plurality of patches; and a mapping of the plurality of logical qubits to the plurality of qubit patches; allocate the plurality of gate operations to a set of layers, whereby determining a reduced number of layers for the quantum circuit, wherein said allocate is performed based on the physical representation and based on an optimization function, wherein the optimization function is configured to minimize a number of the set of layers while complying with layer collision constraints, the plurality of gate operations comprises at least a first gate operation, a second gate operation and a third gate operation, the set of layers comprises at least a first layer, a second layer and a third layer, whereby said allocate comprises designating the first gate operation to the first layer, designating the second gate operation to the second layer, and designating the third gate operation to the third layer, wherein the logical representation indicates that the first gate operation is applied on first and second logical qubits of the plurality of logical qubits, wherein said allocate comprises determining a qubit route between first and second qubit patches of the plurality of qubit patches, the first and second qubit patches representing the first and second logical qubits, respectively, wherein said allocate comprises designating the qubit route to the first layer; and synthesize the quantum circuit according to the set of layers, whereby a synthesized quantum circuit is optimized according to the optimization function.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary lattice of qubits, in accordance with some exemplary embodiments of the disclosed subject matter;

FIG. 2A-2C show an exemplary pre-defined framework, in accordance with some exemplary embodiments of the disclosed subject matter;

FIG. 3 illustrates an exemplary pre-defined framework, in accordance with some exemplary embodiments of the disclosed subject matter;

FIGS. 4A-4B show an exemplary swap of logical qubits, in accordance with some exemplary embodiments of the disclosed subject matter;

FIGS. 5A-5B show an exemplary adjustment of qubit patches, in accordance with some exemplary embodiments of the disclosed subject matter;

FIG. 6 shows an exemplary lattice scheme, in accordance with some exemplary embodiments of the disclosed subject matter;

FIG. 7 shows an exemplary flowchart diagram of a method, in accordance with some exemplary embodiments of the disclosed subject matter;

FIG. 8 shows an exemplary flowchart diagram of a method, in accordance with some exemplary embodiments of the disclosed subject matter; and

FIG. 9 shows an exemplary block diagram of an apparatus, in accordance with some exemplary embodiments of the disclosed subject matter.

### DETAILED DESCRIPTION

One technical problem dealt with by the disclosed subject matter is to provide an efficient error correction scheme for quantum programs. In some exemplary embodiments, quantum error correction may be necessary for quantum computing, e.g., due to the decoherence property of qubits, which causes qubits to lose their quantum properties quickly in the presence of a constant amount of noise per qubit. In some exemplary embodiments, quantum errors may also result from qubit initialization, measurement errors, qubit loss, qubit leakage, or the like.

In some exemplary embodiments, a qubit's quantum state or property may be described by probability amplitudes. In some cases, errors in the qubit state probability amplitudes may propagate rapidly, if not corrected, causing the qubit state to become unusable. In some exemplary embodiments, one or more quantum error correction codes may be deployed in order to correct quantum state errors, such as stabilizer codes, topological error correction codes, or the like. For example, topological error correction codes may comprise a surface code technique.

In some exemplary embodiments, logical representations of quantum circuits may be designed, programmed or created by a user, a programmer, an operator, or the like, using gate-level programming, using functional-level code, using evolutionary computing techniques such as Quantum Genetic Algorithm (QGA), using genetic algorithms, or the like. In some exemplary embodiments, a logical representation of a quantum circuit may comprise a plurality of logical qubits, and a plurality of quantum operations or gates that are to be applied on the logical qubits according to one or more constraints (e.g., precedence constraints). For example, a logical representation of a quantum circuit may comprise a Directed Acyclic Graph (DAG), in which each node represents one or more quantum operations or gates, and each edge represents precedence constraints between the quantum operations. In some cases, a logical representation may be representable by two or more equivalent DAGs that are different from one another.

In some exemplary embodiments, after an initial logical representation of a quantum circuit is created, it may go through multiple stages before becoming an executable quantum circuit that can be executed with a quantum computer, a quantum cloud, a quantum execution platform, a simulation software thereof, or the like. In some exemplary embodiments, during a compilation stage, a physical representation for the logically-represented circuit may be generated to implement the logical representation, e.g., using a quantum error correction code such as surface code. In some exemplary embodiments, while the logical representation may define logical qubits, logical quantum gates, logical cycles, or the like, the physical representation of the quantum circuit may relate to physical qubits of a quantum execution platform, physical gates, or the like. It is noted that a logical qubit, as referred herein, may refer to an individual logical qubit, or to a group of one or more logical qubits, on which quantum operations and manipulations may be performed at a group level.

In some cases, quantum error correcting code may be implemented by a quantum execution platform (e.g., a quantum computer) in order to spread information of at least one logical qubit onto a highly entangled state of several physical qubits. In some exemplary embodiments, this may enable to store the information of the logical qubit onto a highly entangled state of the physical qubits. For example, a topological error correction scheme, such as surface code or color code, may achieve quantum error correction by spreading information of one or more logical qubits onto a set of physical qubits. As an example, surface code may comprise an error correction scheme in which logical qubits are represented by respective sets of physical qubits, while enabling operations between the logical qubits, as disclosed, for example, in Fowler et al. “Surface codes: Towards practical large-scale quantum computation” Phys. Rev. A 86, 032324 (18 Sep. 2012), which is hereby incorporated by reference in its entirety for all purposes without giving rise to disavowment. In some exemplary embodiments, syndrome measurements may be used to determine whether a qubit state has been corrupted, enabling the correction of such errors.

In some exemplary embodiments, a logical representation of a quantum circuit may be implementable by different alternative physical representations of the quantum circuit, all of which implementing the same logical representation in a different manner, e.g., using different error correction schemes, using a different number of qubits, cycles, and/or gates, using different types of qubits and/or gates, or the like. In some exemplary embodiments, when using the same error correction scheme, such as surface code, the logical representation may still be implementable by different alternative physical representations of the quantum circuit, all of which implement the same logical representation in a different manner within the surface code framework.

In some exemplary embodiments, each alternative physical representation of the quantum circuit may comprise a plurality of physical qubits that are manipulated by a plurality of physical gates over a plurality of cycles. In some exemplary embodiments, implementations of a logical representation may differ in their implementation of quantum error correction, which may result with different error rates at the logical level, different execution times, different resource utilizations, or the like. For example, different implementations of quantum error correction may allocate different physical qubits for representing each logical qubit using the surface code. As another example, different implementations of quantum error correction may allocate a different number of physical qubits for each logical qubit. As another example, different implementations of quantum error correction may utilize a different quantity of physical qubits altogether. As another example, different implementations of quantum error correction may order gate operations differently, implement logical gates differently, or the like. In some exemplary embodiments, implementations of the logical representation must all comply with the same constraints, e.g., precedence constraints between at least a subset of the quantum operations, hardware constraints of the execution platform, constraints derived from an error correction code that is being used, or the like.

In some exemplary embodiments, it may be desired to find a physical representation of a quantum circuit that implements quantum error correction optimally, e.g., resulting with a lowest error rate, a lowest resource utilization, a shortest execution time, a combination thereof, or the like, compared to alternative implementations of quantum error correction codes.

Another technical problem dealt with by the disclosed subject matter is to provide an efficient implementation of topological error correction codes for quantum programs. In some exemplary embodiments, topological error correction codes, such as surface code, may constitute a class of quantum error correction codes that relies on the topology of a two-dimensional lattice, a plane, a connectivity graph, an array, or a surface (referred to hereinafter as “lattice” or “plane”), which defines the connectivity of the physical qubits. For example, when implementing surface code, the entire lattice, or portions thereof, may be used to represent one or more logical qubits and to apply thereon quantum operations according to a quantum program. In some exemplary embodiments, the topological error correction may be implemented on any lattice of qubits having two or more dimensions.

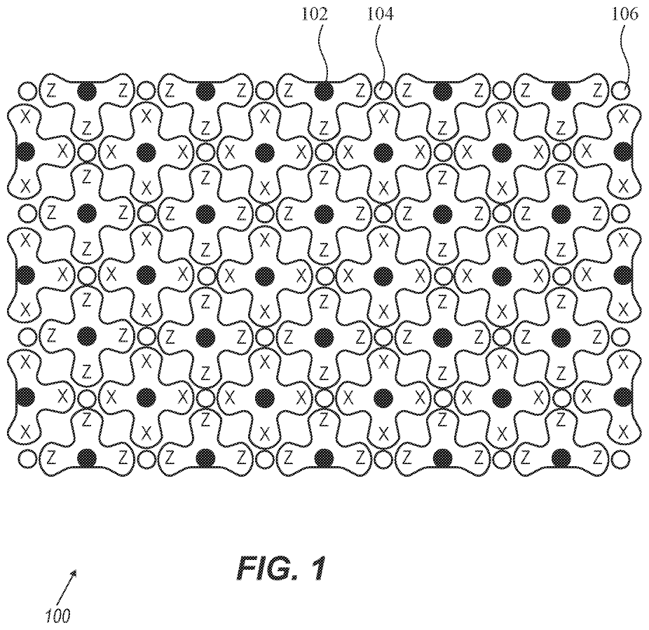

For example, surface code architectures may be employed to periodically correct qubits, e.g., according to the structure depicted in FIG. 1. Referring now to FIG. 1, depicting an exemplary two dimensional lattice of a surface code error correction architecture, in accordance with some exemplary embodiments of the disclosed subject matter. As depicted in FIG. 1, a Lattice 100 may comprise a grid of a plurality of physical qubits, each depicted as a white or black dot, e.g., Qubits 102, 104, and 106. In some exemplary embodiments, Lattice 100 may depict physical qubits that represent, as a group, a plurality of logical qubits, a single logical qubit, or the like.

In some exemplary embodiments, Lattice 100 may depict error correction interactions between the physical qubits. For example, black dots such as Qubit 102, may represent ‘measurement’ qubits that are configured to periodically measure and correct attached qubits. In some exemplary embodiments, measurement qubits may measure physical qubits represented as white dots (e.g., Qubits 104 and 106) if they are directly connected or wired thereto. For example, since Qubit 104 is directly connected to measurement Qubit 102, measurement Qubit 102 may periodically measure and correct the state of Qubit 104. As another example, since Qubit 106 is not directly connected to measurement Qubit 102, measurement Qubit 102 may not directly measure or correct the state of Qubit 106, although the state of Qubit 106 may be entangled with the physical qubits that are coupled directly to Qubit 102 (e.g., the state of Qubit 106 may be entangled with the state of Qubit 104). In some exemplary embodiments, by employing the surface code architecture, a quantum state of a logical qubit represented by Lattice 100 or portion thereof may be stable due to the periodic measurements performed by measuring qubits such as Qubit 102.

In some exemplary embodiments, within the lattice setting, interactions between qubits may be limited to their nearest neighbors in the two-dimensional lattice, e.g., Lattice 100, or in a lattice with any other dimensions. For example, Qubit 106 may not interact with Qubits 102 and 104, since they may not be nearest neighbors within Lattice 100 and may not be connected or physically wired to Qubit 106.

In some exemplary embodiments, in some topological error correction schemes, the lattice grid may be partitioned into a plurality of “tiles”, or unit cells. In some exemplary embodiments, in order to form a tile, all physical qubits in a tile may be directly physically connected to at least one other physical qubit in the tile. In some exemplary embodiments, one or more tiles may be used to host respective “patches” of the lattice, e.g., for representing logical qubits, auxiliary regions for performing operations between logical qubits, or the like. For example, a quantum computer may be partitioned into blocks of tiles, such as qubit patches (also referred to as ‘data blocks’), which host or represent the logical qubits. In some cases, such patches may correspond at least in part to the patches disclosed in D. Litinski. “A Game of Surface Codes: Large-Scale Quantum Computing with Lattice Surgery”. arXiv: 1808.02892 (2018). arxiv.org/abs/1808.02892, which is hereby incorporated by reference in its entirety for all purposes without giving rise to disavowment. In some exemplary embodiments, all physical qubits in a patch may be directly connected or wired to at least one other physical qubit in the patch. In some exemplary embodiments, the patches may have edges that represent logical Pauli operators.

In some cases, a patch of physical qubits may represent a single logical qubit. In some cases, a patch of physical qubits may represent more than one logical qubit, according to an internal distribution of physical qubits to logical qubits within the patch. For example, surface-code patches may comprise one-qubit patches comprising a single tile and representing one logical qubit, two-qubit patches comprising two tiles and representing two logical qubits, or the like. In other cases, patches with any other number of tiles may be associated with two or more logical qubits. In some cases, a logical qubit may be represented by one or more qubit “holes” within a patch, by separate disconnected patches within the lattice, or the like. For example, a hole within a patch may include one or more physical qubits that are not measured periodically as part of the error correction code, and thus do not participate in the error correction scheme, and can be marked as a hole in the patch. In other cases, a logical qubit may be represented in any other manner.

In some exemplary embodiments, operations that are defined in the logical representation of the quantum circuit, may be implemented between patches of the lattice. For example, in case the logical representation of the quantum circuit include a gate operation applied on first and second logical qubits, the gate operation may be applied between a first patch that represents the first logical qubit, and a second patch that represents the second logical qubit, via a path formed in an intermediate auxiliary region between the patches (or directly between adjacent patches). In some exemplary embodiments, operations that can be applied on patches include qubit initializations, qubit measurements, swaps of quantum states, patch deformations, or the like. For example, patch deformations may comprise adjusting a number of qubits in the patch (e.g., thereby increasing or decreasing its size), adjusting a location of the patch within the lattice, adjusting an identity of physical qubits that form the patch, adjusting an outline (e.g., a shape) of the patch in the lattice and corresponding logical Pauli operators, or the like.

In some exemplary embodiments, in addition to representing logical qubits, the lattice may comprise one or more regions that represent auxiliary physical qubits that may be used for applying quantum operations (e.g., gates) between patches of logical qubits. In some cases, an auxiliary region between the patches may comprise physical qubits that do not represent any logical qubit (including auxiliary logical qubits), and can be used for applying quantum operations between patches. For example, in order to swap quantum states between patches, the states may be swapped through the auxiliary region between the patches. In other cases, the auxiliary regions may represent auxiliary logical qubits that may be initialized, used to mediate interactions between other logical qubits, and then may be reset on demand. In some exemplary embodiments, patches that represent logical qubits may be referred to herein as qubit patches, while auxiliary regions may be referred to herein as auxiliary patches. In some cases, auxiliary patches may or may not represent logical auxiliary qubits.

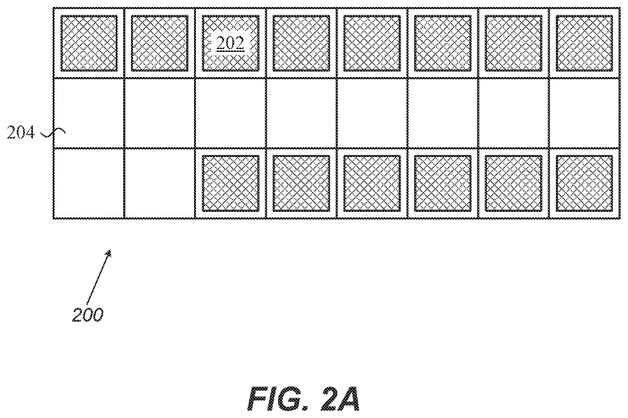

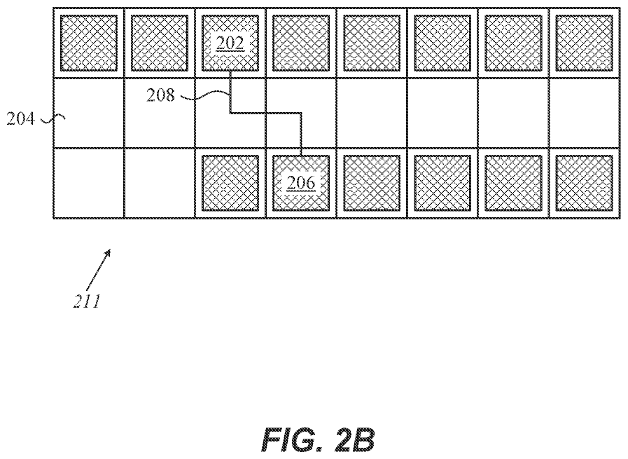

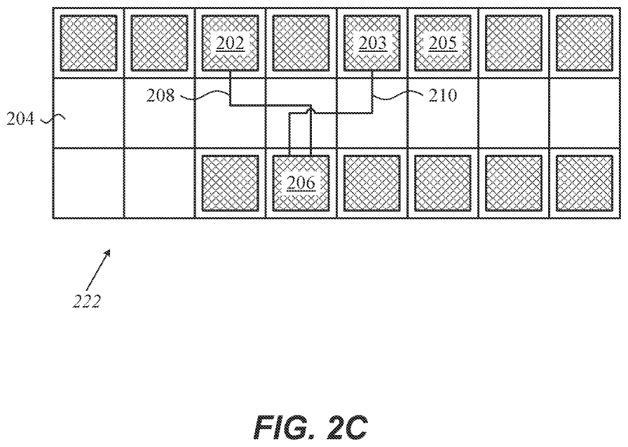

Referring now to FIG. 2A, depicting an exemplary lattice, in accordance with some exemplary embodiments of the disclosed subject matter. As depicted in FIG. 2A, Lattice 200 may be partitioned into patches that represent logical qubits, such as Patch 202. For example, Patch 202 may represent a single logical qubit, a plurality of logical qubits, or the like. In some exemplary embodiments, an auxiliary region such as Auxiliary Patch 204 may be positioned between the qubit patches of Lattice 200, and may enable to apply operations between qubit patches.

In some exemplary embodiments, when applying a quantum operation between two or more qubit patches via an auxiliary patch that is directly wired or connected to the respective qubit patches, a qubit route through which the quantum operation is applied, may be formed within the auxiliary patch. For example, a qubit route between two patches may comprise a continuous route of physical qubits that are all connected or wired. In some exemplary embodiments, a qubit route may be formed without an auxiliary patch, such as directly between two qubit patches that are adjacent and wired to each other. For example, the qubit route may comprise physical qubits belonging to the auxiliary patch, which are used to apply an operation such as a quantum gate between patches. For example, the qubit route may comprise physical qubits that are used to swap a quantum state from a first qubit patch to a second qubit patch. In some exemplary embodiments, qubit routes may be required to comprise a continuous line or other shape of physical qubits, a start of which being wired to the first qubit patch and an end of the route being wired to the second qubit patch.

Referring now to FIG. 2B, depicting an exemplary qubit route, in accordance with some exemplary embodiments of the disclosed subject matter. In some cases, Lattice 211 may correspond to Lattice 200 of FIG. 2A. As depicted in FIG. 2B, Lattice 211 may be partitioned into, or allocated to, qubit patches that represent logical qubits, such as Patches 202 and 206. In some exemplary embodiments, a Qubit Route 208 may be formed between Patches 202 and 206, in order to apply a quantum operation between logical qubits represented by Patches 202 and 206. In some exemplary embodiments, Qubit Route 208 may comprise a continuous line or other shape of physical qubits that reaches edges of both Patches 202 and 206. For example, Qubit Route 208 may utilize physical qubits of an auxiliary region such as Auxiliary Patch 204.

In some exemplary embodiments, qubit routes may be required not to collide with one another during the same cycle of execution, or layer, of a quantum circuit. In some exemplary embodiments, a layer may refer to one or more consecutive cycles of execution. In some exemplary embodiments, this requirement may restrict accessible logical operations in each cycle, as they must all comply with the non-collision requirement. In some exemplary embodiments, qubit routes may be considered to collide in case that a physical qubit in the auxiliary patch is used for two or more qubit routes during a single cycle.

Referring now to FIG. 2C, depicting an exemplary qubit route collision, in accordance with some exemplary embodiments of the disclosed subject matter. In some cases, Lattice 222 may correspond to Lattice 211 of FIG. 2B. As depicted in FIG. 2C, Auxiliary Patch 204 of Lattice 222 may comprise a first Qubit Route 208 between Patches 202 and 206, and a second Qubit Route 210 between Patches 203 and 206. As depicted in FIG. 2C, Qubit Route 208 may collide with Qubit Route 210, and thus both routes may not be implemented during the same layer, cycle of a circuit execution, or the like. In order to implement quantum operations between Patches 203 and 206 and between Patches 202 and 206, Qubit Routes 208 and 210 may be separated to two different layers, or Qubit Routes 208 and 210 may be modified to form alternative routes that do not collide.

In some cases, a qubit route may not pass through Auxiliary Patch 204, such as in case of a direct route. For example, a qubit route between Patches 203 and 205 may be direct, and may not utilize any physical qubits of Auxiliary Patch 204.

In some exemplary embodiments, in addition to qubit patches and auxiliary patches, a lattice may be partitioned into one or more T-factory patches that represent one or more T-factories, T-state producers, or the like. In some exemplary embodiments, universal gates or continuous gates may not necessarily be supported by surface code architectures or other quantum error correction architectures. In some exemplary embodiments, in such cases, in order to apply universal gates, areas of the lattice may be allocated to form one or more T-factories, e.g., within T-factory patches. In some exemplary embodiments, a T-factory may implement one or more logical circuits having a known predefined logical qubits, quantum gates, or the like, which may be used to create universal states. In some exemplary embodiments, T-factory patches may be used to create universal logical states (e.g., magic states or T-states) in qubits of the auxiliary region, as part of a magic state distillation process. For example, T-factory patches may comprise a first patch of a plurality of tiles that is used to distill magic states and a second patch of a plurality of tiles that is used to store the produced magic states until they are consumed. In some exemplary embodiments, logical states created by T-factory patches may be forwarded to edges of qubit patches through one or more qubit routes (e.g., via one or more auxiliary patches). For example, logical states created by T-factory patches may be applied on adjacent auxiliary physical qubits from the auxiliary region, and swapped through a qubit route until reaching an edge of a desired qubit patch. In other cases, physical qubits of the lattice may be allocated to any other type of patch. It is noted that not all the physical qubits of a lattice may be necessarily allocated for implementing a quantum circuit, and some qubits may remain idle and may not be allocated for any patch.

In some exemplary embodiments, it may be desired to provide an efficient partition of a lattice of a topological error correction code into patches, which enhances the performance of a respective quantum circuit. For example, it may be desired to design qubit patches, auxiliary patches, T-factory patches, or the like, properties thereof, or the like, in a manner that enhances a performance of a quantum circuit that is scheduled to be executed.

In some exemplary embodiments, a lattice may be partitioned into patches according to one or more designs, frameworks, or the like, which may have pre-defined characteristics. For example, a lattice may be partitioned into patches with pre-defined characteristics such as a pre-defined size, shape, order between patches, positions of patches, or the like. For example, a pre-defined framework may generate for each logical qubit of the quantum circuit a respective qubit patch with predefined characteristics, for each logical gate of the quantum circuit a respective qubit route with predefined characteristics between qubit patches, or the like.

For example, FIGS. 2A-2C depicts a pre-defined framework in which all logical qubits are represented by respective qubit patches with identical sizes, shapes, or the like, e.g., Patches 202, 203, 205, and 206. In some cases, the pre-defined framework of FIGS. 2A-2C may comprise a predefined structure of patches, in which qubit patches are positioned as two parallel horizontal lines along a latitude axis, and an auxiliary patch is positioned in between the parallel lines of qubit patches. This provides a full connectivity of the qubit patches with one another through Auxiliary Patch 204 or directly between adjacent qubit patches.

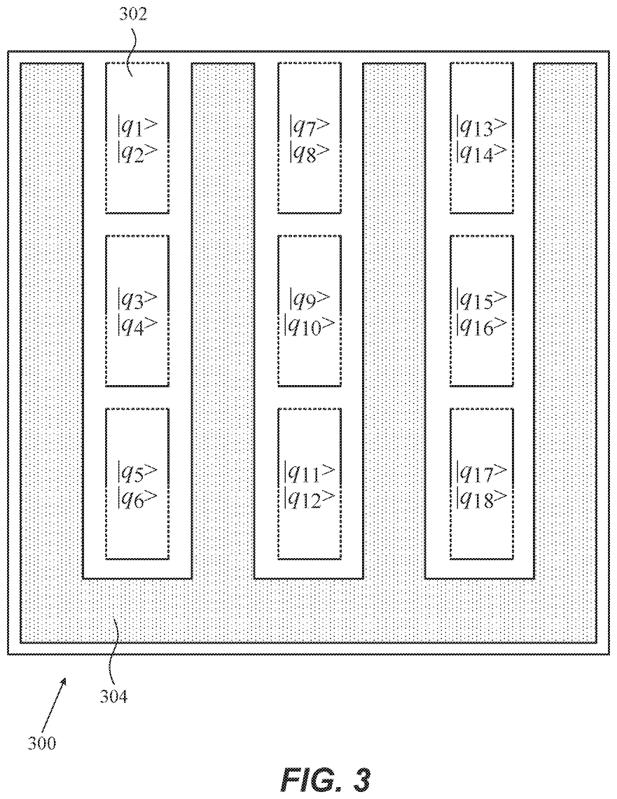

Referring now to FIG. 3, depicting an exemplary pre-defined framework, in accordance with some exemplary embodiments of the disclosed subject matter. In some cases, FIG. 3 depicts an exemplary Pre-Defined Framework 300, different from the pre-defined framework of FIGS. 2A-2C. As depicted in FIG. 3, Pre-Defined Framework 300 comprise a predefined structure of patches, in which pairs of logical qubit are represented by respective 2-qubit patches, and the 2-qubit patches are positioned as a set of vertical rows along longitude axes. For example, Qubit Patch 302 comprises a 2-qubit patch that represents two logical qubits, as predefined in the framework, and has predefined size and shape characteristics.

As depicted in FIG. 3, Pre-Defined Framework 300 may comprise a predefined structure of an Auxiliary Patch 304. For example, Auxiliary Patch 304 may be configured to comprise a set of parallel vertical rows of physical qubits that are adjacent to the vertical rows of 2-qubit patches and crisscross the vertical rows of 2-qubit patches. Auxiliary Patch 304 may be configured to comprise a horizontal row of physical qubits that is perpendicular to the vertical rows of 2-qubit patches, and to the vertical rows of Auxiliary Patch 304, e.g., at a bottom of the lattice. The horizontal row of Auxiliary Patch 304 may provide connectivity between the vertical rows of Auxiliary Patch 304, which enables application of quantum operations between any two qubit patches of Pre-Defined Framework 300.

In some exemplary embodiments, in case a pre-defined framework such as Pre-Defined Framework 300 of FIG. 3 or the pre-defined framework of FIG. 2C is selected, the selected framework may be utilized for implementing a logical representation of a quantum circuit. For example, each logical qubit may be represented using qubit patches with pre-defined properties that are defined by the respective pre-defined framework. As another example, the operations of the quantum circuit may be configured to have pre-defined properties as defined by the respective pre-defined framework. In some exemplary embodiments, pre-defined frameworks may define properties of qubit patches, properties of auxiliary patches, properties of T-factories, or the like, e.g., sizes thereof, shapes thereof, default positions thereof, or the like. For example, a pre-defined framework may define that every logical qubit of the quantum circuit that is intended to be executed, may be represented by a qubit patch of a defined shape and size, e.g., a polygon shape such as a square.

In some exemplary embodiments, using a pre-defined framework may be suboptimal, due to one or more factors. For example, pre-defined frameworks may be wasteful in resources, as they may be configured to ensure full connectivity of all qubit patches, while a quantum circuit implemented using a pre-defined framework may not necessarily require a full connectivity between all qubit patches during the entire execution. As another example, pre-defined frameworks may define unified sizes and properties to patches of the same type, while this may not necessarily be optimal for a quantum circuit implemented using a pre-defined framework. As another example, pre-defined frameworks may define a static framework, while this may not necessarily be optimal for a quantum circuit implemented using a pre-defined framework.

For example, in some cases it may be preferable to allocate a greater number of physical qubits for a qubit patch that represents an output logical qubit, compared to other logical qubits (e.g., auxiliary logical qubits), as this may reduce the error rate of the entire quantum circuit's output. As another example, in case some logical qubits are manipulated more times than other qubits, utilizing same qubit patches for all qubits may not be optimal, as the error rate of the qubits that are manipulated more may be greater, and the importance of their quantum state may be greater as well. Another example arises in the choice of shape and size of lattice portions (e.g., physical qubits) that are allocated to logical qubits of the T-factory patches In some exemplary embodiments, since a T-factory may implement a known predefined logical circuit, with predefined logical qubits and gates, it may be preferable to select the layout and dimensions of the respective T-factory patch in a dynamic manner that minimizes the space-time footprint (e.g., the lattice space occupied by the patch and the number of cycles used thereby) and maximized the output fidelity of the T-states produced by the T-factory patch. In some cases, one or more adjustments of T-factory implementations are disclosed in D. Litinski. “Magic State Distillation: Not as Costly as You Think”. arXiv: 1905.06903. Quantum 3, 205 (2019), which is hereby incorporated by reference in its entirety for all purposes without giving rise to disavowment. As another example, determining an order between qubit patches that does not take into account the number of quantum operations between each two patches, may result with a suboptimal and non-efficient execution. For example, positioning two qubit patches that are manipulated a plurality of times together at a large distance, may require a plurality of long qubit routes, e.g., potentially causing more collisions, which increases execution time and is wasteful in resources compared to short qubit routes.

In some exemplary embodiments, using a pre-defined framework may be suboptimal, at least since the pre-defined framework may not be optimal for reaching an objective of a user that is executing a quantum circuit. In some exemplary embodiments, pre-defined frameworks that optimize on execution time may utilize more space of the lattice, and vice versa, thereby defining a tradeoff between these factors. For example, a pre-defined framework may design data patches to be compact, but may require to move and rotate qubits when attempting to access them. As another example, a pre-defined framework may be configured to store qubit patches in rows, while leaving auxiliary patches between the rows, e.g., as depicted in FIG. 3, which reduces an execution time of programs implemented by the pre-defined framework on the expense of a large and wasteful auxiliary region. As another example, all qubit patches may be stored in a single row, such as in order to speed up operations, on the expense of requiring a large and wasteful portion of a lattice. As another example, D. Litinski suggests a “fast data block” pre-defined structure that allows all-to-all connectivity of patches (while still being limited in terms of the operations that can be executed simultaneously without collisions), on the expense of requiring a large and wasteful portion of a lattice. In some exemplary embodiments, the tradeoff represented by each pre-defined framework may not match an objective of a user that is executing a quantum circuit. For example, the user may not desire to speed up operations on the expense of requiring a large and wasteful portion of a lattice, thus causing the framework to be suboptimal. As another example, even if the user may desire to speed up operations on the expense of requiring more physical qubits of a lattice, using a pre-defined framework may not provide optimal results due to inherent limitations and constraints of predefining a same framework for all quantum programs.

Yet another technical problem dealt with by the disclosed subject matter is to overcome drawbacks of pre-defined frameworks, and provide a framework that is not pre-defined. For example, it may be desired to provide a dynamic or adjustable framework that partitions a lattice into patches of one or more types, for each scheduled program. The dynamic framework may comprise a framework that is specifically tailored to match properties of a quantum circuit that is configured to be implemented over the lattice, which is specifically tailored to match an objective associated with the quantum circuit, or the like. For example, in case the objective of the execution is to reduce the execution time, the dynamic framework may be adjusted accordingly. In some cases, it may be desired to provide, for a quantum circuit, an adjustable framework that is not identical for all quantum circuits, e.g., that allows qubit patches that are scheduled to be idle to be stored compactly (e.g., without auxiliary regions), and that allows qubit patches that are scheduled to be highly active, to be stored with a high connectivity (via the auxiliary patches).

In some exemplary embodiments, any adjustment of the division of the lattice to patches, such as an adjustment of a position of a qubit patch, a size of a qubit patch, a shape of a qubit patch, or the like, may affect the performance of the entire circuit execution. For example, in case two patches represent two logical qubits that are manipulated by many common gates, and they are physically located relatively far from one another (a distance greater than a threshold), the circuit execution may become longer (in terms of cycles) and an error rate of the output quantum state may become higher, compared to a configuration in which the two patches are positioned adjacent to each other, e.g., due to the longer qubit routes, increased collisions between qubit routes, longer duration during which the logical qubits are prone to uncorrectable errors, or the like. As another example, in case a patch that represents a logical qubit is increased in size, e.g., indicating that a greater number of physical qubits are allocated to the patch and included therein, an error rate of the patch may be decreased, and vice versa.

Yet another technical problem dealt with by the disclosed subject matter is to optimize the division of the lattice to patches, while taking into account effects of different patch properties on the performance of the quantum circuit. It may be desired to provide an optimization that takes into account factors such as the identity and physical connectivity properties of physical qubits of each patch, properties of potential auxiliary patches, or the like, which may all effect on the performance of the quantum circuit.

Yet another technical problem dealt with by the disclosed subject matter is to optimize the division of the lattice to patches, while taking into account the possibility of dynamically adjusting the division of the lattice to patches during execution of a quantum circuit. In some exemplary embodiments, in surface code, the physical qubit placement and connectivity of the patches is assumed to be static, although it can be dynamically adjusted. In some exemplary embodiments, a qubit patch may be dynamically adjusted during an execution of the quantum circuit, such as by changing a size of qubit ‘holes’ in the qubit patch, changing a size of the patch, changing a relative position of the patch within the lattice, or the like.

Yet another technical problem dealt with by the disclosed subject matter is to optimize the division of the lattice to patches, while taking into account the possibility of modifying the logical representation of the quantum circuit. In some exemplary embodiments, the logical representation may be adjustable in one or more manners without changing a result of the quantum circuit, such as by selecting a different order between gate executions that have no precedence constraints between them. For example, different circuit adjustments are disclosed in U.S. Pat. No. 11,416,762 B1, titled “Selecting Physical Qubits For Quantum Error Correction Schemes”, filed Apr. 14, 2022, which is hereby incorporated by reference in its entirety for all purposes without giving rise to disavowment.

Yet another technical problem dealt with by the disclosed subject matter is to overcome drawbacks of dynamic error correction schemes disclosed in U.S. Pat. No. 11,615,337 B1, titled “Determining Quantum Error Correction Schemes”, filed Apr. 18, 2022, which is hereby incorporated by reference in its entirety for all purposes without giving rise to disavowment. In some exemplary embodiments, the dynamic error correction scheme in U.S. Pat. No. 11,615,337 B1 may be suboptimal, at least since it may not take into account a plurality of properties that affect the efficiency of the circuit execution. For example, the dynamic error correction scheme may not necessarily take into account the identity and physical connectivity properties of the physical qubits, which may have a significant effect on the execution of the quantum circuit. It may be desired to overcome these limitations, and provide an optimization that takes these factors into account.

One technical solution provided by the disclosed subject matter may comprise determining, for a given quantum circuit that is scheduled to be executed over a lattice, a division of at least a portion of the lattice to patches, and scheduled routes for performing quantum operations of the quantum circuit between the patches. In some exemplary embodiments, the patches and scheduled routes may be determined based on an optimization function that takes into account a full range of properties, characteristics, and attributes of the patches, the lattice, the quantum circuit, or the like. In some exemplary embodiments, the division of the lattice to patches, and the scheduled routes between the patches, may be referred to as a “lattice scheme”.

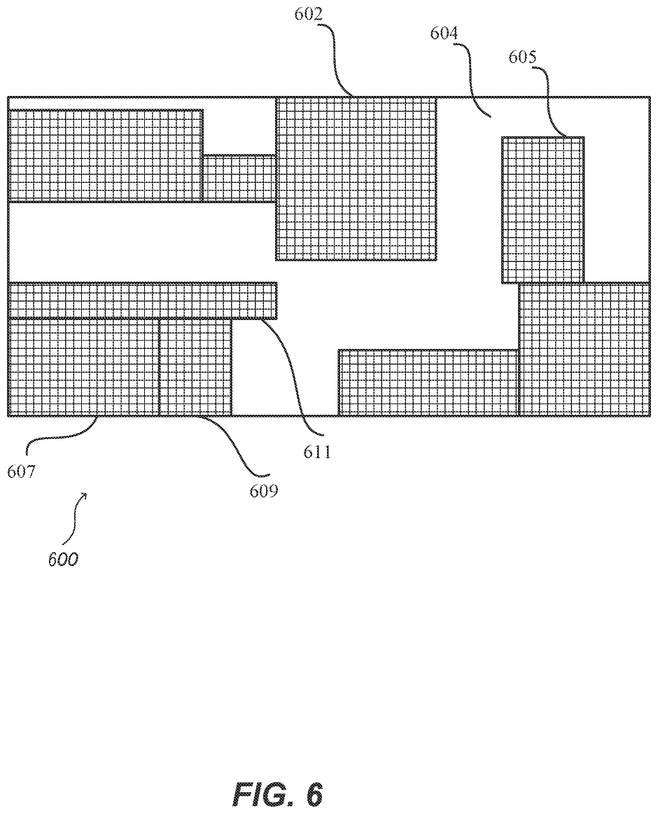

In some exemplary embodiments, a lattice scheme may be determined dynamically for an obtained quantum program, as part of an adjustable topological error correction scheme that is not predefined, and is specifically tailored to each quantum circuit. In some exemplary embodiments, physical qubits of the lattice may be allocated to a plurality of patches such as qubit patches, auxiliary patches, T-factory patches, or the like, e.g., according to the optimization function. In some cases, the lattice may be divided into non-unified qubit patches, non-unified auxiliary patches, or the like, which may differ for different quantum circuits, e.g., as depicted in FIG. 6. For example, an implementation of a first quantum circuit may comprise three qubit patches with ten physical qubits and four qubit patches with fifteen qubits, while an implementation of a second quantum circuit may comprise eight qubit patches with three qubits each.

In some exemplary embodiments, the optimization function may be configured to obtain, as input, a logical representation of a quantum circuit, and hardware properties of the quantum execution platform over which the quantum circuit is scheduled to be executed, such as lattice properties of the quantum execution platform, a number of available qubits of the lattice, quantum operations that are applicable by the lattice, or the like. For example, the input may comprise a logical representation of the circuit including multi-qubit gates, a DAG representing the circuit, an indication of a quantum execution platform, hardware properties of the quantum execution platform (e.g., a plane of physical qubits available at the platform and their connectivity properties), or the like.

In some exemplary embodiments, the optimization function may be configured to generate, or indicate, a lattice scheme that implements the logical representation over the lattice and optimizes an objective function. In some exemplary embodiments, the lattice scheme may be represented by a set of parameters that define the number of patches, the type of each patch, the size of each patch, the position and shape of each patch with respect to the lattice (e.g., indices of physical qubits of the lattice allocated to each patch), routes for applying operations between the patches, a division of routes into layers, an overall number of physical qubits that are allocated to the implementation, or the like.

In some exemplary embodiments, an optimized lattice scheme may be determined, calculated, selected, or the like, according to the optimization function. In some exemplary embodiments, the optimization function may be configured to find, for parameters that represent a plurality of lattice schemes, values of the parameters that represent an optimized lattice scheme. It is noted that the term ‘optimal’ or ‘optimized’, as used herein, may refer to a solution that comprises a global optimum, a local optimum, or neither. In some cases, an optimal solution may refer to a solution that complies with one or more thresholds, which complies with one or more constraints, which is within a defined range of sufficiently good results, which is within a defined percentile of the results, or the like.

In some exemplary embodiments, the optimization function may be configured to maximize or minimize an objective function, a cost function, or the like, associated with at least a subset of the parameters. In some exemplary embodiments, the objective function may quantify a performance, quality, or efficiency of a lattice scheme for a set of selected parameters, and the optimization function may adjust the values of the parameters to achieve the best possible outcome, e.g., a lowest value, a highest value, or the like. For example the objective function may measure whether an implementation increases the efficiency of the quantum circuit compared to other implementations, the performance of its execution, or the like. In some exemplary embodiments, the optimization function may be configured to minimize or maximize a parameterized objective function that measures a number of cycles, an estimated execution time of the quantum circuit, a number of physical qubits utilized by the execution, an effective proportion of the lattice that is allocated to the execution, an error rate of the output, or the like. For example, the optimization function may provide valuations of parameters that represent an optimal physical representation of the quantum circuit.

In some exemplary embodiments, the optimization function may be configured to minimize an objective function that measures costs of implementations of the quantum circuit, in order to identify an implementation of the quantum circuit that is associated with a minimal cost, while complying with constraints. For example, the objective function may comprise a weighted or unweighted cost function that quantifies a number of physical qubits, cycles, and an error rate of a quantum circuit, using one or more weights. According to this example, the objective function may be set by the user to include default settings (e.g., default weights). For example, the objective function may be configured to score a number of cycles that is estimated to be required for executing the quantum circuit, its error rate, its resource utilization, or the like, according to predefined weights. As another example, the cost function may be configured to assign a cost to each resource that is used, such as cycles and physical qubits, to assign a cost to error rates (e.g., to each reduction in an error rate unit), or the like. In some cases, the cost function may assign the same or different weights to different resources, properties, error rates, or the like.

In some exemplary embodiments, the optimization function may be implemented by one or more constraint solvers, heuristic algorithms, predictors, or the like. For example, the optimization function may be implemented by a constraint solver that is configured to provide valuations of parameters that comply with all of the constraints of the quantum execution platform and the quantum circuit, while reducing a weighted or non-weighted cost function.

In some exemplary embodiments, an implementation of a quantum circuit may be represented by a set of parameters that define the number of patches, the type of each patch, the size of each patch, the position and shape of each patch with respect to the lattice (e.g., indices of physical qubits of the lattice allocated to each patch), routes for applying operations between the patches, a division of routes into layers, an overall number of physical qubits that are allocated to the implementation, or the like. In some exemplary embodiments, the set of parameters may have corresponding domains and constraints. In some exemplary embodiments, the domains of the set of parameters, and constraints thereof, may be set according to properties of the lattice such as its overall size, properties of patches, properties of qubit routes, or the like.

In some exemplary embodiments, constraints of the set of parameters may comprise hardware constraints (of the quantum execution platform, its lattice, or the like), user constraints (e.g., a maximal error rate that is tolerable to the user, maximum execution time, a minimal number of physical qubits that should be used, an objective function of the user, or the like), circuit constraints (requiring a number of specified quantum operations between specified logical qubits, precedence constraints), or the like. For example, the constraints may be determined based on the logical representation of the quantum circuit (e.g., precedence constraints).

In some exemplary embodiments, constraints of the set of parameters may be determined based on the topological error correction scheme of the lattice. For example, the topological error correction scheme may incorporate constraints on the lattice, such as based on its enablement of dynamic adjustments of patches, its dynamic properties, its prohibition of collisions between qubit routes during a same cycle, its prohibition of applying quantum operations between qubit patches that are not adjacent and have no auxiliary region between them, or the like. For example, the topological error correction scheme used by a quantum execution platform may define that qubit routes cannot collide within a same layer, or any other surface code structure constraints.

In some exemplary embodiments, constraints of the set of parameters may comprise local constraints of each parameter, global constraints of the set of parameters, or the like. For example, an overall number of physical qubits in the lattice may constitute a global constraint on the allocation of qubits to patches. According to this example, a domain of a first parameter that defines a patch size may be generated to comprise a range between zero and the number of physical qubits in the lattice. According to this example, a domain of a second parameter that defines a patch size may be generated to comprise a range between zero and the number of physical qubits of the lattice remaining after allocating qubits to the first parameter. As another example, a domain of a patch parameter defining a patch may be generated to have a global constraint indicating that physical qubits of the lattice that were used by other patches, cannot be used again by the respective patch. As another example, the domain of the patch parameter may be generated to have a local constraint defining that all physical qubits in the patch must be connected with one or more connections to other qubits in the patch (e.g., the patch cannot include an isolated physical qubit that is not attached to any other physical qubit in the patch). As another example, the domain of the patch parameter may be generated to have a global constraint defining that the domain may not include values that, when added to values of other patches, result with a sum that is greater than the number of physical qubits in the lattice.

In some exemplary embodiments, the constraints of the set of parameters may be determined for a parameter of the set of parameters, for a subset of parameters, for the entire set of parameters, for domains of the set of parameters, or the like.

In some exemplary embodiments, the set of parameters may be defined to represent the identity and physical connectivity properties of physical qubits of each patch. For example, the set of parameters may comprise a parameter that defines, for each patch, a selection of physical qubits that constitute the patch (e.g., indicated by the qubit indices). As another example, the set of parameters may comprise a parameter that defines, for each physical qubit in a patch, the physical connectivity properties between the physical qubit and other qubits of the patch. According to these examples, the domains and constraints of such parameters may be defined to limit the allocation of physical qubits for each patch according to hardware constraints of the quantum execution platform.

In some exemplary embodiments, the set of parameters may be defined to represent a property defining that each patch of physical qubits can potentially represent more than one logical qubit simultaneously (via tile holes or via separate tiles). For example, the set of parameters may comprise a parameter that defines, for each patch, a number of logical qubits represented thereby, with a corresponding domain. For example, the domain may be defined to include a range of 1-2, in case qubit patches can be used to represent only one or two logical qubits, or any other range corresponding to other capabilities of qubit patches to represent other numbers of logical qubits. As another example, the domain of the parameter may be defined to include a range that corresponds to the number of tiles in the patch (e.g., 1-3 qubits for a patch of 3 tiles). In some cases, different quantum execution platforms may differ in the number of logical qubits that can be represented by each patch.

In some exemplary embodiments, the set of parameters may be defined to represent various shapes and sizes of auxiliary patches, without the auxiliary patches being required to necessarily connect all qubit patches. In some exemplary embodiments, there may be a tradeoff between a level of compactness of the qubit patches, indicating how compactly they are positioned, and the connectivity limitations of the resulting implementation. In some exemplary embodiments, as the auxiliary region is larger, the level of compactness of the qubit patches may be decreased, but the connectivity of the patches may be increased. For example, a fully compact circuit implementation may have no auxiliary patches at all, thereby saving qubit resources, but may not enable any quantum operations to be applied between qubit patches. In some exemplary embodiments, this tradeoff is explored, for example, by D. Litinski, as referred to above.

In some exemplary embodiments, the set of parameters may be defined to represent various shapes and sizes of T-factory patches In some cases, the set of parameters may comprise a binary parameter that defines, for each two adjacent patches, whether or not they are connected via an auxiliary patch. In some cases, the set of parameters may comprise a parameter that defines, for each two adjacent patches, a size and shape of an auxiliary region between the patches, e.g., in case they are connected via the auxiliary region. In other cases, all qubit may be defined by a parameter measuring a size of an auxiliary region between them, and in case of absence of a connecting auxiliary region, the size may be set to zero.

In some exemplary embodiments, the set of parameters may define, for each gate of the quantum circuit, one or more qubit patches over which the gate is scheduled to be defined according to the logical representation (e.g., the patches representing logical qubits that are manipulated by the gate in the logical representation). In some exemplary embodiments, the set of parameters may define, for each gate of the quantum circuit, a qubit route for implementing the gate. In some exemplary embodiments, the qubit route may comprise a set of physical qubits in the lattice (e.g., represented by their indices) allocated to one or more auxiliary patches, connecting two (or more) respective qubit patches over which the gate is defined. In some exemplary embodiments, the qubit route may be represented by a parameter defining a selection of indices of physical qubits within auxiliary regions that form a route between edges of the two (or more) qubit patches.

In some exemplary embodiments, the set of parameters may define, for each quantum operation of the quantum circuit, a layer or cycle of the quantum operation. In some exemplary embodiments, quantum operations such as gates may be binned into respective layers, such that quantum operations within the same layers have non-colliding routes. For example, a layer of a gate may represent a cycle during which the gate should be applied via a respective qubit route, alone or together with other quantum operations that have non-colliding qubit routes.

In some exemplary embodiments, the set of parameters may define one or more dynamic adjustments of the parameters. In some exemplary embodiments, a topological error correction scheme may enable a plurality of parameter adjustments during execution of a circuit, such as dynamic adjustments of patches' sizes, shapes, and positions, adjustments of logical qubit representations, or the like. For example, the size and location of a patch may be adjusted dynamically during execution. In some exemplary embodiments, incremental swaps between layers may be supported by some topological error correction schemes.

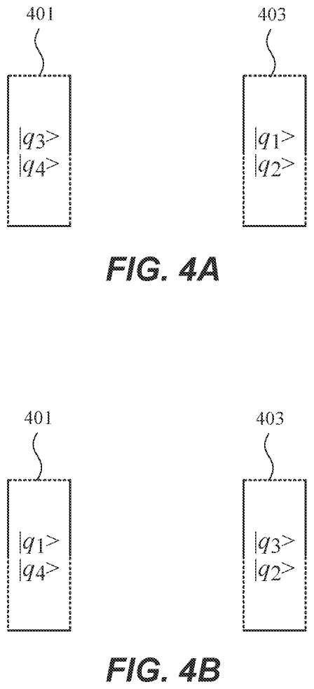

In some exemplary embodiments, one or more constraints on the dynamic adjustments may define whether or not each parameter can be changed during execution, how each parameter can be changed, to what extent the parameter can be adjusted, or the like. In some exemplary embodiments, a topological error correction scheme may enable qubit patches to be moved dynamically any distance within the lattice at any execution cycle. For example, referring back to FIG. 2C, Patches 202 and 203 may switch positions, or may be moved to any other location on the lattice, within one or more execution cycles. In some exemplary embodiments, a topological error correction scheme may enable to dynamically swap logical qubits represented by respective qubit patches, e.g., as depicted in FIGS. 4A-4B.

Referring now to FIGS. 4A-4B, depicting an exemplary swap of logical qubits, in accordance with some exemplary embodiments of the disclosed subject matter. As depicted in FIG. 4A, Qubit Patch 403 may comprise a two-qubit patch that represents first and second logical qubits, denoted q1 and q2. Qubit Patch 401 may comprise a second two-qubit patch that represents third and fourth logical qubits, denoted q3 and q4. According to this example, the first and third logical qubits may be swapped, resulting with Qubit Patch 403 representing the second and third logical qubits, e.g., q3 and q2, and with Qubit Patch 401 representing the first and fourth logical qubits, e.g., q1 and q4, as depicted in FIG. 4B. According to this example, although the logical qubits are swapped, the positions of Qubit Patches 401 and 403 are unchanged, static, or the like. In other cases, any other swap may be performed between representations of logical qubits. In some exemplary embodiments, the set of parameters may be generated to define whether or not swap operations occur between logical qubits.

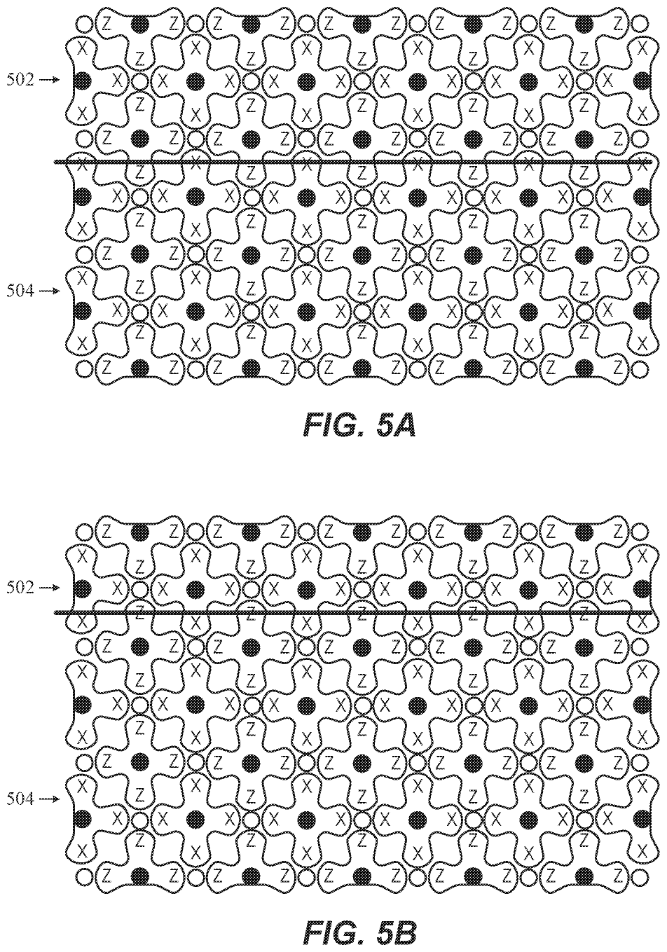

In some exemplary embodiments, a topological error correction scheme may enable dynamically adjusting sizes and shapes of patches at any execution cycle. As an example, at every execution cycle, physical qubits may be dynamically swapped from first patches to second patches, thereby increasing the size of the second patches on the expense of the first patches, e.g., as depicted in FIGS. 5A-5B. Referring now to FIGS. 5A-5B, depicting an exemplary adjustment of qubit patches, in accordance with some exemplary embodiments of the disclosed subject matter. As depicted in FIG. 5A, Qubit Patch 502 may comprise a first set of physical qubits, while Qubit Patch 504 may comprise a second set of physical qubits. During execution, the number of qubits may be dynamically adjusted between patches. For example, as depicted in FIG. 5B, physical qubits from Qubit Patch 502 may be dynamically allocated to Qubit Patch 504, causing Qubit Patch 504 to increase in size and Qubit Patch 502 to decrease in size during execution. In other cases, any other change in allocation of physical qubits may be performed between execution cycles, layers, or the like.

In some exemplary embodiments, the set of parameters may be generated to define allocations of each patch for each layer or cycle. In some cases, the set of parameters may comprise a parameter that defines, for each patch of the quantum circuit, whether or not it performs each dynamic operation that is enabled by the respective topological error correction scheme, which dynamic operation is performed thereby, at which cycles the dynamic operations are performed, or the like. For example, the set of parameters may comprise a parameter that defines, for each patch, whether or not it is scheduled to move to a different position during execution, a location of the patch over time, or the like. As another example, the set of parameters may comprise a parameter that defines, for each patch, whether or not its logical qubits are configured to be swapped, with which patch the qubits are scheduled to be swapped, or the like. As another example, the set of parameters may comprise a parameter that defines, for each patch, a number and/or identity of physical qubits allocated to the patch over time.

In some exemplary embodiments, the optimization function may be configured to obtain the set of parameters, domains of their values, constraints thereof, or the like, and to determine an optimal lattice scheme according to an objective function. In some exemplary embodiments, the determined lattice scheme may or may not comprise dynamic adjustments such as changes to patches' positions, shapes, representations of logical qubits, and sizes during runtime.

In some exemplary embodiments, in case dynamic operations are taken into account by the optimization function, the objective function may be configured to assign a cost of each dynamic operation, dynamic adjustment, or the like, which is performed by each alternative lattice scheme. In some cases, a cost function may be adjusted to calculate a cost of a dynamic adjustment of a parameter, as well as the cost of not performing the dynamic adjustment, and determine whether or not to perform the dynamic adjustment according to a difference in the costs complying with a threshold. For example, a constraint of the objective function may define that dynamic adjustments may only be performed in case the difference between the cost of the dynamic adjustment and the cost of not performing the dynamic adjustment is greater than a threshold.

In some exemplary embodiments, the optimization function may be configured to output at least one set of valuations for the set of parameters, which complies with all the constraints, and optimizes, locally or globally, on the objective function. In some exemplary embodiments, the set of valuations may represent a lattice scheme that is feasible, which utilizes the least amount of resources (e.g., cycles, gates, or the like), which is estimated to obtain a lowest error rate, a defined balance between them, or the like, e.g., as defined by the objective function. For example, the set of valuations of the parameters' domains may be set to minimize an objective function that measures the costs of different lattice schemes implementing a quantum circuit, and comply with the constraints of the set of parameters.

In some exemplary embodiments, the optimization function may be configured to terminate its execution upon identifying one set of valuations for the set of parameters that complies with all the constraints and optimizes, locally or globally, on the objective function, or may be configured to terminate upon identifying all of the possible sets of valuations, a subset thereof, a defined number of valuations, or the like.

In some exemplary embodiments, the optimization function may be implemented by one or more constraint solvers, heuristic algorithms, predictors, or the like. For example, the optimization function may define a Constraint Satisfaction Problem (CSP) that corresponds to the set of parameters, its domains, its constraints, or the like. According to this example, the global and local constraints may be added to the CSP problem as constraints, and the domains of the parameters may be adjusted to correspond to the constraints, to user settings, to properties of the quantum execution platform, to properties of the quantum circuit, or the like.

In some exemplary embodiments, the optimization function may utilize a CSP solver to solve the CSP, thereby obtaining a valuation of the parameters that represents a lattice scheme that minimizes the objective function while complying with the local constraints of each parameter, global constraints of the set of parameters, determined domains of each parameter, or the like. In other cases, any other optimizer or constraint solver may be utilized in addition to or instead the CSP solver.

In some cases, the optimization function may deploy one or more search algorithms in order to select an optimal lattice scheme. For example, the search algorithms may be employed in a solution space that includes the domains of each parameter, constraints thereof, or the like, such that each valuation that complies with the constraints represents a different feasible implementation of the quantum circuit. In some cases, a search algorithm may be configured to terminate upon finding one or more sets of valuations for parameters that comply with the constraints and domains, and may be considered optimal according to the objective function. In some cases, the search algorithms may utilize a predictor to predict the error rates, execution time, or the like, of implementations associated with different valuation.

Referring now to FIG. 6, depicting an exemplary lattice scheme, in accordance with some exemplary embodiments of the disclosed subject matter.

In some exemplary embodiments, executing the optimization function for a given objective function, logical representation of a quantum circuit, and quantum execution platform, may provide a valuation of parameters that represents a lattice scheme such as Lattice Scheme 600. In some exemplary embodiments, since the framework of Lattice Scheme 600 is not pre-configured, and is specifically tailored for the set of valuations, the sizes and shapes of the patches may vary rather than being uniform or standardized. For example, Patch 602 and Patch 605 may have different sizes (number of physical qubits), and different shapes (square versus rectangle), although they may both represent logical qubits. In some exemplary embodiments, the positions of the patches may vary rather than being uniform or standardized. For example, Patch 602 and Patch 605 may start at different latitudes of the lattice, end at different latitudes of the lattice, or the like.

In some exemplary embodiments, the optimization function may be executed as a single iteration, such as executing once a CSP solver over all constraints and domains, or by a plurality of execution iterations, stages, or the like. In some cases, determining valuations for the lattice scheme may constitute an assignment problem that is highly complex, at least when enabling dynamic adjustments. In some cases, a CSP solver (e.g., or a search algorithm) may be executed on a device that may not necessarily have sufficient computational resources for solving the CSP during a single execution. In such cases, the optimization problem may be separated into a plurality of stages, which may or may not be executed simultaneously, separately, sequentially, or the like, in order to detect an optimal lattice scheme. For example, a CSP solver may be executed in two or more iterations over subsets of the solution space, a heuristics solver may be executed in two or more iterations, or the like.

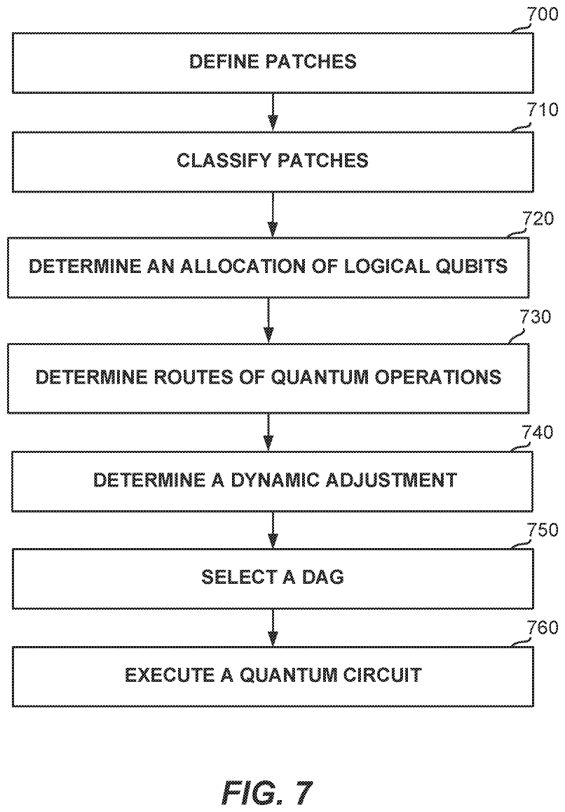

In some exemplary embodiments, computations of the optimization function may be implemented over a plurality of stages, phases, or the like. In some exemplary embodiments, the optimization function may be executed over a number of defined stages, e.g., according to the method of FIG. 7, or according to any other method, order of steps, or the like. For example, the Steps of FIG. 7 may be performed in any other order, e.g., in a sequential order differing from the order of the steps of FIG. 7, simultaneously, at one or more overlapping time frames, or the like.

Referring now to FIG. 7, showing an exemplary flowchart diagram of a method, in accordance with some exemplary embodiments of the disclosed subject matter.

On Step 700, the optimization function may obtain, as input, a first partial lattice scheme. In some exemplary embodiments, the first partial lattice scheme may comprise a lattice that is not divided into patches. In some cases, the first partial lattice scheme may indicate a number of physical qubits of the lattice that are allocated to the quantum circuit, indices of physical qubits that can be utilized for the quantum circuit, or the like. In other cases, all available physical qubits of the lattice may be assumed to be usable by the quantum circuit, and may be utilized by this step.

In some exemplary embodiments, during this step, the optimization function may process the first partial lattice scheme, and allocate sets of physical qubits to different patches, e.g., thereby defining a set of patches. In some exemplary embodiments, it may allocate a subset of the physical qubits of the lattice for the patches, or may allocate all of the physical qubits to patches. In some exemplary embodiments, the optimization function may allocate qubits to patches according to an objective function, a cost function, or the like. In some exemplary embodiments, the optimization function may define for each patch a location on the lattice (e.g., indicated by indices of respective physical qubits in the lattice), a size (a number of physical qubits in the lattice belonging to the patch), or the like. For example, patches may be selected randomly and provided to Step 710, and one or more resulting lattice schemes having a lowest number of layers (e.g., as determined on Step 710) may be selected.

On Step 710, the optimization function may obtain, as input, a second partial lattice scheme. For example, the second partial lattice scheme may be obtained from another step of FIG. 7 (e.g., from Step 700), from a random allocation generator, or the like.

In some exemplary embodiments, the second partial lattice scheme may comprise a lattice that is divided to a plurality of patches, each patch having a selected location on the lattice (e.g., indicated by indices of respective physical qubits in the lattice), a selected size (a number of physical qubits in the lattice belonging to the patch), or the like. In some exemplary embodiments, the second partial lattice scheme may not comprise a classification of patches. For example, the patches may not be classified as qubit patches, auxiliary patches, or T-factory patches.

In some exemplary embodiments, during this step, the optimization function may process the second partial lattice scheme, and determine roles or classifications for the patches. In some exemplary embodiments, the optimization function may select, for each patch, whether the patch should be a qubit patch, an auxiliary patch, a T-factory patch, or the like, e.g., according to an objective function, a cost function, or the like. For example, roles of patches may be selected randomly and provided to Step 720, and one or more results having the lowest number of layers may be selected. In some exemplary embodiments, the placement of T-factories that allow universal computation may be selected such that they are accessible to qubit patches on which the T-states are scheduled to be applied.

On Step 720, the optimization function may obtain, as input, a third partial lattice scheme. For example, the third partial lattice scheme may be recursively obtained from another step of FIG. 7 (e.g., from Step 710), from a random allocation generator, or the like.

In some exemplary embodiments, the third partial lattice scheme may comprise a lattice that is divided to a plurality of patches, each patch having a selected location on the lattice (e.g., indicated by indices of respective physical qubits in the lattice), a selected size (a number of physical qubits in the lattice belonging to the patch), or the like. In some exemplary embodiments, the third partial lattice scheme may comprise roles or classifications of patches to auxiliary regions, qubit patches, and T-factories. In some exemplary embodiments, the third partial lattice scheme may not comprise an allocation of logical qubits to qubit patches.

In some exemplary embodiments, during this step, the optimization function may process the third partial lattice scheme, and determine an allocation of logical qubits from the logical representation of the quantum circuit to qubit patches. In some exemplary embodiments, since gates between different logical qubits can be applied when the respective qubit patches are adjacent to one another, or when they are connected via one or more auxiliary regions, the optimization function may determine an allocation of logical qubits to qubit patches that enables to perform the quantum operations defined in the quantum circuit.

In some exemplary embodiments, the optimization function may determine an allocation of logical qubits to each qubit patch according to an objective function, a cost function, or the like. In some exemplary embodiments, the optimization function may determine an allocation of logical qubits to each qubit patch based on heuristic algorithms, a CSP solver, an objective function, randomly, or the like. For example, the optimization function may allocate logical qubits to qubit patches randomly, according to one or more criteria, or the like, and provide them to Step 730. According to this example, the random allocation that results with the smallest number of layers at Step 730, may be selected by Step 720.

In some exemplary embodiments, logical qubits may be matched patches according to a defined order of patch inspections, randomly, a search algorithm, heuristics, or the like. As an example, a heuristic algorithm may be configured to first select an allocation of a logical qubit for the largest patch (in terms of number of physical qubits) in the third partial lattice scheme, then, from the remaining logical qubits, the heuristic algorithm may select an allocation to the second largest patch, and so on. As another example, a heuristic algorithm may be configured to first select an allocation of a logical qubit for the most central patch in the third partial lattice scheme (with respect to the lattice), then, from the remaining logical qubits, the heuristic algorithm may select an allocation to the second most central patch, and so on.

In some exemplary embodiments, logical qubits may be allocated to patches based on parameters such as a distance between an inspected patch and other patches, a number of gates that are applied between the inspected patch and each of the other patches, or the like. For example, a parameter defining a distance between patches may be set for each pair of patches, and a parameter defining a number of applied gates may be set for each pair of logical qubits. In some exemplary embodiments, for each inspected patch, logical qubits may be allocated in a manner that takes into account the number of operations that are applied on pairs of logical qubits, such that the distance between patches that are manipulated by a large number of gates is minimized. For example, pairs of logical qubits that are not manipulated by any shared gates, can be allocated to qubit patches with an infinite distance between them, e.g., in case there is no qubit route that can connect the qubit patches.

In some cases, a greedy algorithm may be applied to select, for each inspected patch, a logical qubit that shares a largest number of gates (compared to remaining logical qubits that were not yet allocated) with adjacent patches that were already selected. In such cases, the greedy algorithm may initialize by allocating a logical qubit manipulated by the largest number of gates, to the most central or largest patch. In some cases, a non-greedy algorithm may be applied to select, for each inspected patch, a logical qubit that optimizes a defined objective function. For example, the objective function may comprise a cost function that measures, for each pair of patches, a number of quantum operations between the patches and a distance between the patches, with or without defined weights. According to this example, an optimization function may attempt to minimize a distance between patches that represent logical qubits with many shared gates, such as by maximizing a ratio of the number of gates to the distance between the patches.

In some exemplary embodiments, after selecting a qubit patch for each logical qubit, the optimization function may output a resulting lattice scheme, and provide it to Step 730 for further processing. In case Step 730 was already executed for selecting the allocation of logical qubits to patches, the previously retained results may be used, and Step 730 may be skipped. In some exemplary embodiments, selecting a qubit patch for each logical qubit may release a constraint on the allocations of logical qubits to qubit patches, thereby simplifying the assignment problem.

On Step 730, the optimization function may obtain, as input, a fourth partial lattice scheme. For example, the fourth partial lattice scheme may be recursively obtained from another step of FIG. 7 (e.g., from Step 720), from a random allocation generator, or the like.

In some exemplary embodiments, the fourth partial lattice scheme may comprise a lattice that is divided to a plurality of patches (e.g., qubit patches, auxiliary patches, T-factory patches, or the like), each patch having a selected position on the lattice (e.g., indicated by indices of respective physical qubits in the lattice that are allocated to the patch), a selected size (a number of physical qubits in the lattice belonging to the patch), a classification, or the like. In some exemplary embodiments, the fourth partial lattice scheme may comprise an allocation of logical qubits from the logical representation of the quantum circuit, for each qubit patch. For example, a logical qubit may be allocated to a one-qubit patch, two logical qubits may be allocated to a two-qubit patch, or the like.

In some exemplary embodiments, during this step, the optimization function may obtain the fourth partial lattice scheme, and process the scheme to obtain an executable implementation of a quantum circuit, a static lattice scheme, or the like. In some exemplary embodiments, the optimization function may process the fourth partial lattice scheme to determine qubit routes for performing the quantum operations of the quantum circuits between patches. In some exemplary embodiments, the optimization function may determine the qubit routes such that a number of layers to which the routes can be allocated, is minimal. For example, the qubit routes may be determined such that they can be binned into a minimal number of layers without any collisions between qubit routes of the same layer. It is noted that a layer may correspond to a single cycle of execution, to two or more cycles, or the like.

In some exemplary embodiments, within a single layer, quantum operations performed via qubit routes may be performed simultaneously, at partially overlapping times, or the like, and therefore qubit routes therein may be required to not collide. In some exemplary embodiments, the optimization function may divide the quantum operations defined by the logical representation of the quantum circuit between layers, such that each layer comprises one or more quantum operations that do not collide. In some exemplary embodiments, the optimization function may attempt to identify an allocation of quantum operations to layers, which minimizes the number of layers. In some cases, an objective function may measure a number of layers for a set of determined qubit routes, and the optimization function may be configured to minimize the objective function.

In some exemplary embodiments, the optimization function may utilize one or more optimizers such as CSP solvers, search algorithms, heuristic algorithms, or the like, for determining the qubit routes and allocating them to layers. For example, a CSP solver may be executed on the parameters of the fourth partial lattice scheme, which may constitute of a partially solved problem that is less complex than solving an entire lattice scheme, and determine a valuation of parameters that results with a minimized number of layers (e.g., global or local). As another example, heuristic algorithms, such as greedy algorithms, may be utilized to reduce the number of layers. For example, a heuristic algorithm may allocate all quantum operations to a single layer, split therefrom colliding operations in a defined order or priority (e.g., according to the instantaneous state of the lattice's connectivity map), or the like, until eliminating collisions from all layers while complying with precedence constraints of the quantum circuit. For example, in case two qubit routes within a same layer collide and cannot be rerouted to a non-colliding qubit route, the layer may be split to two, thereby increasing the number of layers to a minimum.

In some exemplary embodiments, achieving a minimal number of layers (also referred to as the number of cycles or the ‘depth’ of the circuit), may reduce the execution time of the circuit, which, in turn, may reduce the error rate of the execution.

On Step 740, the optimization function may obtain, as input, a fifth partial lattice scheme. For example, the fifth partial lattice scheme may be recursively obtained from another step of FIG. 7 (e.g., from Step 730), from a random allocation generator, or the like.

In some exemplary embodiments, the fifth partial lattice scheme may correspond to the static lattice scheme, as generated by Step 730. For example, the fifth partial lattice scheme may comprise a lattice that is divided to a plurality of classified patches (e.g., classified as qubit patches, auxiliary patches, T-factory patches, or the like), each patch having a selected position on the lattice, a selected size, a classification, or the like. In some exemplary embodiments, the fifth partial lattice scheme may comprise an allocation of logical qubits to qubit patches and qubit routes between patches.

In some exemplary embodiments, during this step, the optimization function may be configured to process the fifth partial lattice scheme to determine one or more dynamic adjustments for the execution of the quantum circuit. In some exemplary embodiments, by encoding qubits as patches of the surface code, the size of each of these patches may be selected statically or dynamically, affecting the resulting logical error rate. In some exemplary embodiments, the placement of the patches may be selected statically or dynamically.

For example, one or more dynamic adjustments may be made during the execution that adjust defined positions of patches, their sizes, the allocation of logical qubits to patches, or the like. As another example, the fifth partial lattice scheme may define static sizes of patches at a start of the execution, and the optimization function may determine one or more dynamic adjustments that can be made during the execution of the circuit. In some exemplary embodiments, the optimization function may output one or more dynamic changes of properties of patches, dynamic changes of logical qubit allocations, allocations of the dynamic changes to layers (e.g., utilizing Step 730), order constraints between different dynamic changes, or the like.

In some exemplary embodiments, the dynamic adjustments may be determined according to an objective function, e.g., measuring a number of resources utilized by an execution of a resulting quantum circuit, a number of cycles utilized by an execution of a resulting quantum circuit, an estimated error rate of a resulting quantum circuit, or the like. In some exemplary embodiments, the dynamic adjustments may be determined based on heuristics, a CSP solver, an objective function, or the like. For example, in case a first positioning of qubit patches is optimal for a first phase of the quantum circuit execution, but not for a second phase of the execution, it may be desired to adjust the positions so that the positions are optimal throughout the execution. As another example, it may be desired to allow qubit patches that are scheduled to be idle for a period of the execution to be stored compactly (e.g., without auxiliary regions, or with a thin layer of the auxiliary patch) during that period, and to be stored with higher connectivity during other time periods, e.g., according to the gates that are scheduled for each patch during each cycle.

As an example, referring back to FIG. 6, a qubit patch may be moved to a place without access to the auxiliary layer, for an idle period of the patch. For example, Patches 607 and 609 may be dynamically moved to be adjacent to one another, as depicted in their relative position in FIG. 6, without any retaining access to Auxiliary Region 604 for communicating between Patches 607 and 609. For example, this adjustment may be performed in case that a logical qubit represented by Patch 607 is scheduled to be manipulated in the remaining execution only by gates that are shared with Patches 609 or 611 (e.g., with which Patch 607 is directly wired). As another example, this adjustment may be performed during a first phase of execution in which Patches 607 and 609 are manipulated together, and Patches 607 and 609 may be moved to a second location subsequently for a second phase of execution. For example, in case Patch 607 is scheduled to be manipulated together with Patch 605 for the second phase, Patch 607 may be moved to be adjacent to Patch 605 during the second phase.

In some exemplary embodiments, storing Patch 607 compactly, as depicted in FIG. 6, may reduce a number of qubits that are allocated to Auxiliary Region 604, and potentially reduce a total number of qubits utilized by the lattice scheme, without adversely affecting the lattice scheme's ability to implement all the quantum operations of the quantum circuit.

As another example, in case that Patches 607, 609, and 611 are not scheduled for any quantum operation for a long period of time (e.g., more than a threshold number of cycles, layers, or the like), Patches 607, 609, and 611 may be dynamically moved to the positions depicted in FIG. 6, and at the end of the period of time, may be moved back to their previous positions. In some exemplary embodiments, it may be beneficial to store Patches 607, 609, and 611 more compactly for their idle period of time, as it may enable other patches that are not idle to use a greater number of physical qubits.

On Step 750, the optimization function may be configured to obtain a sixth partial lattice scheme, along with the logical representation of the quantum circuit. For example, the logical representation may comprise a DAG in which the nodes represent the plurality of gate operations of the quantum circuit, and the edges between the nodes represent precedence constraints between the plurality of gate operations. In some exemplary embodiments, the sixth partial lattice scheme may correspond to the static lattice scheme, as generated by Step 730, or to the dynamically adjusted lattice scheme, as generated by Step 740.

In some exemplary embodiments, during this step, the optimization function may process the DAG, to determine one or more adjustments to the DAG that comply with DAG constraints, thereby determining a plurality of alternative DAGs. For example, DAG constraints may indicate whether or not an order between nodes can be changed. In some cases, DAG constraints may be marked by the DAG itself, be indicated via metadata, may be determined independently based on the DAG, or the like. In some exemplary embodiments, the optimization function may determine, for each alternative DAG, a lattice scheme according to Steps 710-740 or portion thereof. In some exemplary embodiments, the optimization function may select, from the alternative DAGs, one that results with a best implementation of the quantum circuit (e.g., according to the objective function, according to a number of layers, or the like).

On Step 760, a resulting lattice scheme may be synthesized, to obtain an executable quantum circuit, and the circuit may be executed on the respective quantum execution platform. For example, the lattice scheme may be obtained from Step 750, Step 740, or the like.

One technical effect obtained by the disclosed subject matter is providing an efficient error correction scheme for quantum programs, within the domain of topological error correction codes, without being limited by drawbacks of pre-defined frameworks. The disclosed subject matter dynamically determines a lattice scheme that matches an objective function of the user, is specifically tailored for each quantum program, or the like.

Another technical effect obtained by the disclosed subject matter is providing an optimized lattice scheme for each obtained logical representation of a quantum circuit. In some exemplary embodiments, the lattice scheme is optimized by taking into account effects of different patch properties on the performance of the quantum circuit, by taking into account the possibility of dynamically adjusting the properties of the lattice scheme during execution of a quantum circuit, by taking into account the possibility of modifying the logical representation of the quantum circuit, or the like.

Yet another technical effect obtained by the disclosed subject matter is utilizing optimizers such as CSP solvers to dynamically generate optimized lattice schemes. For example, by representing the space of possible implementations using parameters, a plurality of constraint solvers may be used to find a valuation that provides optimized results.

Yet another technical effect obtained by the disclosed subject matter is enabling to enhance a quantum error correction scheme using non-uniform allocation of physical qubits to patches. In some exemplary embodiments, instead of dividing the physical qubits of the lattice equally among the patches, the disclosed subject matter provides for performing a non-uniform allocation that takes into account properties of the quantum program, properties of the lattice, an optimization function, or the like.

The disclosed subject matter may provide for one or more technical improvements over any pre-existing technique and any technique that has previously become routine or conventional in the art. Additional technical problems, solutions, and effects may be apparent to a person of ordinary skill in the art in view of the present disclosure.

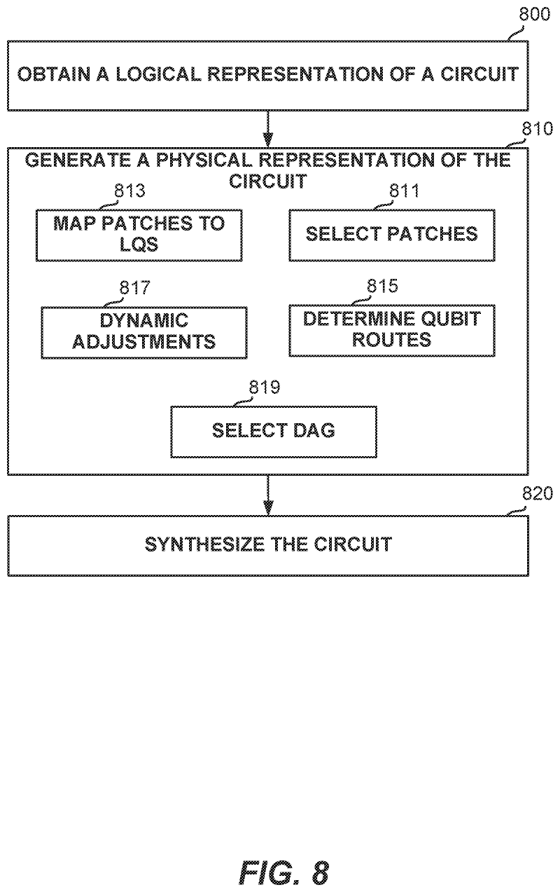

Referring now to FIG. 8, showing an exemplary flowchart diagram of a method, in accordance with some exemplary embodiments of the disclosed subject matter.

On Step 800, a logical representation of a quantum circuit may be obtained, generated, or the like. In some exemplary embodiments, the logical representation may comprise a plurality of logical qubits that are manipulated by a plurality of gate operations. For example, the plurality of gate operations may be defined to be applied on subsets of the plurality of logical qubits. In some exemplary embodiments, the logical qubits may comprise one or more output qubits, through which the logical representation of the quantum circuit may be configured to provide an output.

In some cases, the logical representation of the quantum circuit may comprise a Directed Acyclic Graph (DAG). In some exemplary embodiments, the nodes of the DAG may represent the plurality of gate operations, and the edges between the nodes may represent precedence constraints between the plurality of gate operations. In some exemplary embodiments, precedence constraints of the logical representation may be represented in any other way.

In some exemplary embodiments, the quantum circuit may be scheduled to be executed by a quantum execution platform, such as a quantum computer, a quantum cloud, or the like. In some exemplary embodiments, the quantum computer may comprise a set of physical qubits positioned on a lattice, plane, connectivity graph, surface or the like, which may be embedded in at least two dimensions. For example, the quantum execution platform may comprise a plurality of physical qubits represented as a lattice of two dimensions, three dimensions, or the like. In some exemplary embodiments, the plane may comprise a mapping of physical connectivity links between each pair of physical qubits of the set of physical qubits (e.g., a connectivity map). In some exemplary embodiments, each two physical qubits may be either connected or not connected, e.g., physically via wires.

In some exemplary embodiments, a lattice scheme may be configured to implement an error correcting mechanism (e.g., including the error correction schemes), such as using a surface code architecture. In some exemplary embodiments, the lattice scheme may comprise a physical representation of the quantum circuit. In some exemplary embodiments, the error correcting mechanism implemented by the lattice scheme may be used to correct one or more errors, thus preventing the errors from accumulating between cycles in an uncontrolled manner. In some exemplary embodiments, the error correcting mechanism may be used to reduce quantum noise of logical qubits, to reduce an error rate of logical qubits, to reduce decoherence errors of the program, or the like. For example, at least some logical qubits may be represented by multiple physical qubits.

In some exemplary embodiments, the logical representation of the quantum circuit may be implementable on the quantum execution platform by a plurality of alternative physical representations of the quantum circuit. In some exemplary embodiments, each alternative physical representation of the quantum circuit may implement the logical representation of the circuit in a different way, e.g., with a different allocation of Physical Qubits (PQs) to qubits patches, a different allocation of PQs to auxiliary patches, a different allocation of PQs to T-factories, a different mapping of Logical Qubits (LQs) to qubit patches, a different dynamic adjustment of the allocation, a different overall number of PQs that are used, or the like. In some exemplary embodiments, each alternative physical representation may comprise a lattice scheme utilizing a plurality of PQs (e.g., potentially different pluralities of PQs), which may be used to represent the plurality of LQs.

On Step 810, a physical representation of the quantum circuit on a quantum computer may be obtained, generated, or the like. In some exemplary embodiments, the physical representation may utilize a surface code technique for representing the plurality of logical qubits. In some exemplary embodiments, the physical representation may be generated based on precedence constraints of the logical representation, based on hardware constraints of the quantum execution platform, based on an optimization function, an objective function of the user, or the like.

In some exemplary embodiments, the physical representation may be generated based on an optimization function that is configured to reduce an overall error rate of the quantum circuit, a runtime of the quantum circuit, a total number of physical qubits that is allocated to the physical representation, an average number of physical qubits that is allocated to the physical representation per cycle, a weighted combination thereof, or the like.

In some exemplary embodiments, the optimization function may define a CSP that corresponds to the quantum circuit, and comprises variables, domains and constraints, e.g., as described above. In some exemplary embodiments, each variable may have a corresponding domain that defines one or more potential values of the variable. In some exemplary embodiments, the constraints may define one or more constraints on values of the variables or portion thereof, on their domains, or the like. In some exemplary embodiments, the CSP may comprise parameters defining borders and relative locations of a plurality of qubit patches within the plane, borders and relative locations of one or more auxiliary patches within the plane, a mapping of a plurality of logical qubits of the logical representation to the plurality of patches, or the like. In some exemplary embodiments, the constraints may comprise the layer collision constraints, precedence constraints between the plurality of gate operations, collision constraints on qubit routes of a same layer, surface code constraints, hardware constraints associated with the plane of at least two dimensions, or the like. In some exemplary embodiments, the physical representation may be generated by utilizing a CSP solver to solve the CSP in one or more iterations. For example, the CSP may be solved by a single execution, or by a plurality of executions, e.g., according to Steps 700-750 of FIG. 7. In some exemplary embodiments, a solution of the CSP may define an optimal lattice scheme; a physical representation of the quantum circuit.

In some exemplary embodiments, the physical representation may be generated, e.g., according to Steps 811-819. In some exemplary embodiments, a predictor may be configured to predict or estimate an effect of Steps 811-819 on error rates of the circuit, on a performance of the circuit, an execution time of the circuit, or the like. In some exemplary embodiments, the predictor may estimate a quality of a lattice scheme, using one or more metrics, evaluators, functions, or the like. For example, the predictor may comprise a machine learning predictor, a heuristics-based predictor, or any other type of estimator, calculator, predictor, or the like.

On Step 811, the physical representation may be generated to comprise a division of the set of physical qubits into a plurality of patches, e.g., a plurality of qubit patches, one or more auxiliary patches, one or more T-factory patches, or the like. In some exemplary embodiments, the selection of properties of the patches (e.g., their size) and their classification as auxiliary patches, qubit patches, or the like, may correspond to Steps 700-710 of FIG. 7. In some exemplary embodiments, errors of qubits in the patches may be iteratively corrected every error correction layer of the surface code technique.

In some exemplary embodiments, the qubit patches may be configured to represent the plurality of logical qubits of the logical representation (e.g., input qubits, auxiliary qubits, output qubits, or the like). In some exemplary embodiments, the T-factory patches may represent T-factories for producing magic states. In some exemplary embodiments, the auxiliary patches may be configured to represent an auxiliary region for performing quantum operations such as the plurality of gate operations between at least a subset of the qubit patches. In some exemplary embodiments, the auxiliary region may be used for implementing qubit routes between the subset of the plurality of qubit patches. In some exemplary embodiments, the plurality of gate operations may be implemented via the auxiliary patches, such as by transferring a quantum state from a first qubit patch, via the auxiliary region, to a second qubit patch.

In some exemplary embodiments, each patch may comprise a respective group of physical qubits from the set of physical qubits of the lattice. In some exemplary embodiments, each group may comprise connected physical qubits, such that no patch comprises an isolated physical qubit that is not physically connected to any other physical qubit in the same patch. In some exemplary embodiments, the plurality of patches may be disjoint, e.g., may be selected such that no qubit in the set of physical qubits belongs to more than one patch of the plurality of patches. For example, each physical qubit of the lattice may belong to at most a single patch of any type.

In some exemplary embodiments, properties of patches may be determined dynamically, such as based on an optimization function, the logical representation, and constraints of the quantum execution platform. For example, properties such as a size of the patch, a relative location of the patch in the plane, a shape of the patch within the plane, a type of the patch (e.g., auxiliary), or the like, may be determined for qubit patches, auxiliary patches and T-factory patches.

On Step 813, the physical representation may be generated to comprise a mapping of the plurality of logical qubits to the plurality of qubit patches. In some exemplary embodiments, for each logical qubit, a patch from the plurality of qubit patches may be selected for representing the logical qubit, e.g., similarly to Step 720 of FIG. 7. For example, a single qubit patch may be selected for representing two or more logical qubits. As another example, a single qubit patch may be selected for representing a single logical qubit.

On Step 815, the physical representation may be generated to comprise a set of scheduled qubit routes, e.g., according to Step 730 of FIG. 7. In some exemplary embodiments, for each gate operation that is configured by the logical representation to be applied on first and second logical qubits, a respective qubit route between the first and second qubit patches may be determined, selected, scheduled, or the like. In some exemplary embodiments, the auxiliary region may be used for implementing the qubit routes between the qubit patches. In some exemplary embodiments, a qubit route between first and second qubit patches may comprise qubits from one or more auxiliary patches that physically connect edges of the first and second qubit patches.

In some exemplary embodiments, the plurality of gate operations may be allocated to a set of ordered layers, cycles, or the like, to be implemented via qubit routes. In some exemplary embodiments, gate operations may be allocated to each layer in case they are designated to be implemented by the layer during an execution of the quantum circuit. In some exemplary embodiments, gate operations may be allocated to a same layer in case their qubit routes do not collide, and a simultaneous execution of the gate operation does not contradict precedence constraints. In some exemplary embodiments, no two gate operations of two different layers may be designated to be implemented during a single layer or cycle of the execution. In some exemplary embodiments, the plurality of gate operations may be allocated to a set of layers based on an optimization function, based on one or more properties of the physical representation, or the like.

In some exemplary embodiments, the allocation of gate operations to layers may define a number of cycles to be executed. In some exemplary embodiments, qubit routes implementing the gate operations may be selected in a manner that enables them to implement the gate operations using a minimal number of layers, while ensuring that no layer has any collisions between its qubit routes. For example, a reduced number of layers for the quantum circuit may be determined by selecting a first allocation of gate operations to layers and not a second allocation of gate operations to layers, e.g., along with respective qubit routes. In some exemplary embodiments, the optimization function may be configured to minimize the number of layers while complying with layer collision constraints. In some exemplary embodiments, the layer collision constraints may define that qubit routes for implementing the plurality of gate operations between the plurality of patches cannot collide with other qubit routes within a same layer.

In one scenario, the plurality of gate operations may comprise at least first, second, and third gate operations, which may be designated to first, second, and third layers, respectively. In this scenario, the logical representation may indicate that the first gate operation is applied on first and second logical qubits, resulting with a determination of a qubit route between first and second qubit patches that represent the first and second logical qubits, respectively. In some cases, the qubit route may be designated to a layer, e.g., the first layer. In this scenario, the layer collision constraints may define that the qubit route between the first and second qubit patches must not collide with any other qubit route within the first layer.

On Step 817, the physical representation may be generated to comprise one or more dynamic adjustments of patch properties, e.g., according to Step 740 of FIG. 7. In some exemplary embodiments, one or more properties of a patch may be determined to be dynamically adjusted during an execution of the synthesized quantum circuit on the quantum computer. In some exemplary embodiments, the property may comprise a size of the patch, a relative location of the patch (e.g., its outline) in the plane, a shape of at least one patch within the plane, a mapping of logical qubits to physical qubits, a classification of a patch, or the like.

In some exemplary embodiments, dynamically adjusting a property of a patch may comprise changing the property after a start of the execution of the circuit, such as at an intermediate cycle or layer thereof. For example, in case gate operations are applied a plurality of times on first and second qubit patches within one or more layers that are subsequent to an intermediate layer of the plurality of layers, and a qubit path between the first and second qubit patches is determined to be longer than a threshold, a relative location of the second qubit patch in the plane may be dynamically adjusted, after the intermediate layer is executed, to a second relative location in the plane that is adjacent to the first qubit patch.

On Step 819, the physical representation may be selected by adjusting the logical representation of the quantum circuit, e.g., according to Step 750 of FIG. 7. For example, a DAG of the quantum circuit may be adjusted in one or more ways, and the optimization function may select an adjustment of the DAG that results with a better lattice scheme. In some exemplary embodiments, the DAG may be adjusted in accordance with constraints, such as precedence constraints, hardware constraints, or the like.

On Step 820, the quantum circuit may be synthesized, e.g., according to the determined lattice scheme. In some exemplary embodiments, the quantum circuit may be synthesized according to the qubit routes determined on Step 815, which may optimize the circuit according to the optimization function. In some exemplary embodiments, the quantum circuit may be synthesized according to the properties of patches determined on Step 811. In some exemplary embodiments, the quantum circuit may be synthesized according to a mapping between logical qubits and qubit patches determined on Step 813. In some exemplary embodiments, the quantum circuit may be synthesized according to one or more dynamic adjustments to properties of patches, to the mapping, or to the layers, as determined on Step 817. In some exemplary embodiments, the quantum circuit may be synthesized according to a selected adjustment of the logical representation, its DAG, or the like, e.g., as determined on Step 819.

In some exemplary embodiments, the synthesized quantum circuit may be simulated, executed, or the like, e.g., on a quantum execution platform. In some exemplary embodiments, during an execution of the synthesized quantum circuit, one or more gate operations that are allocated to each layer of the plurality of layers may be designated to be implemented by a respective layer.

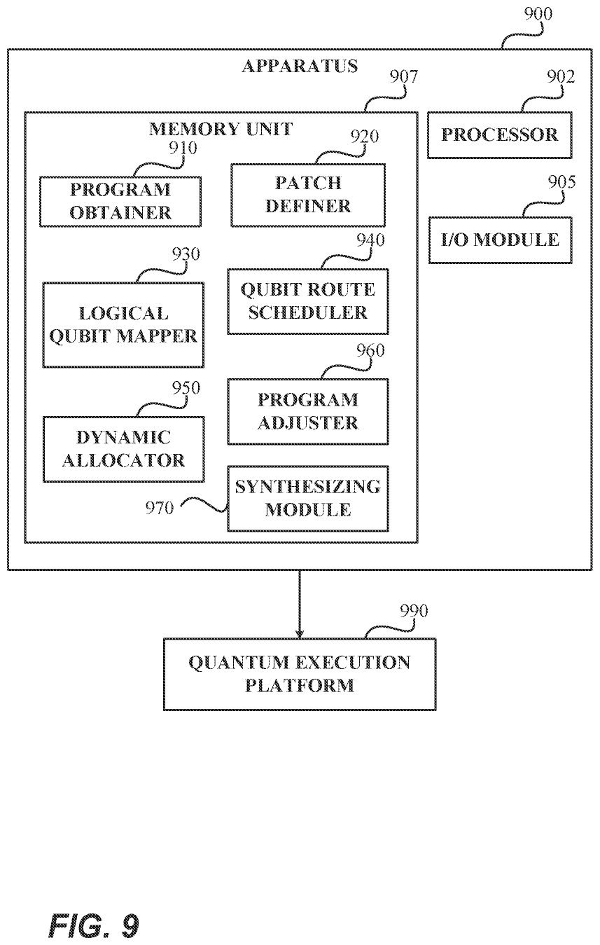

Referring now to FIG. 9 showing a block diagram of an apparatus, in accordance with some exemplary embodiments of the disclosed subject matter.

In some exemplary embodiments, Apparatus 900 may comprise one or more Processor(s) 902. Processor 902 may be a Central Processing Unit (CPU), a microprocessor, an electronic circuit, an Integrated Circuit (IC) or the like. Processor 902 may be utilized to perform computations required by Apparatus 900 or any of its subcomponents. It is noted that Processor 902 may be a traditional classical processor, and not necessarily a quantum processor.

In some exemplary embodiments of the disclosed subject matter, Apparatus 900 may comprise an Input/Output (I/O) module 905. I/O Module 905 may be utilized to provide an output to and receive input from a user, an apparatus, or the like, such as, for example to obtain a user-defined quantum program, to obtain a user-defined objective function, showing circuit illustrations, communicating with quantum hardware, or the like.

In some exemplary embodiments, Apparatus 900 may comprise Memory 907. Memory 907 may be a hard disk drive, a Flash disk, a Random Access Memory (RAM), a memory chip, or the like. In some exemplary embodiments, Memory 907 may retain program code operative to cause Processor 902 to perform acts associated with any of the subcomponents of Apparatus 900. Memory 907 may comprise one or more components as detailed below, implemented as executables, libraries, static libraries, functions, or any other executable components.

In some exemplary embodiments, Memory 907 may comprise a Program Obtainer 910. Program Obtainer 910 may obtain a quantum program, e.g., a logical representation of a quantum circuit, from a user, a server, a computing device, or the like. Program Obtainer 910 may obtain the quantum program via I/O Module 905.

In some exemplary embodiments, Memory 907 may comprise a Patch Definer 920, which may be configured to define properties of qubit patches, auxiliary patches, T-factory patches, or the like. In some exemplary embodiments, Patch Definer 920 may define classifications of patches as qubit patches, auxiliary patches, T-factory patches. In some exemplary embodiments, Patch Definer 920 may define properties of patches, such as their sizes, positions, or the like.

In some exemplary embodiments, Memory 907 may comprise a Logical Qubit Mapper 930, which may be configured to map logical qubits to qubit patches determined by Patch Definer 920. In some exemplary embodiments, Logical Qubit Mapper 930 may map one or more logical qubit to each qubit patch determined by Patch Definer 920.

In some exemplary embodiments, Memory 907 may comprise a Qubit Route Scheduler 940. In some exemplary embodiments, Qubit Route Scheduler 940 may be configured to determine one or more schedules or qubit routes between patches, e.g., qubit patches, T-factory patches, or the like. In some exemplary embodiments, the qubit routes may comprise direct routes between patches, or indirect routes via an auxiliary qubit region.

In some exemplary embodiments, Memory 907 may comprise a Dynamic Allocator 950. In some exemplary embodiments, Dynamic Allocator 950 may be configured to determine one or more adjustments in properties of the patches, in qubit routes between the patches, in mappings of the patches to logical qubits, or the like.

In some exemplary embodiments, Memory 907 may comprise a Program Adjuster 960. Program Adjuster 960 may be configured to modify the logical representation of the circuit to obtain an equivalent logical representation that can be better optimized.

In some exemplary embodiments, Synthesizing Module 970 may be configured to synthesize quantum circuits according to an optimal lattice scheme determined by Qubit Route Scheduler 940, Dynamic Allocator 950, Program Adjuster 960, or the like. In some cases, Synthesizing Module 970 may be configured to execute synthesized quantum circuits onto Quantum Execution Platform 990, or any other execution platform, to be executed thereby. In some cases, Synthesizing Module 970 may simulate execution of the quantum circuit using an emulator, a simulator, or the like, on a classic computer, instead of actual execution by Quantum Execution Platform 990.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining a logical representation of a quantum circuit, wherein the logical representation comprises a plurality of logical qubits, wherein the logical representation defines a plurality of gate operations on subsets of the plurality of logical qubits;
obtaining a physical representation of the quantum circuit on a quantum computer, the quantum computer comprising a set of physical qubits positioned on a plane embedded in at least two dimensions, the physical representation comprising:
a division of the set of physical qubits into a plurality of patches, the plurality of patches comprising a plurality of qubit patches and one or more auxiliary patches, wherein no qubit in the set of physical qubits belongs to more than one patch of the plurality of patches; and
a mapping of the plurality of logical qubits to the plurality of qubit patches;
allocating the plurality of gate operations to a set of layers, whereby determining a reduced number of layers for the quantum circuit, wherein said allocating is performed based on the physical representation and based on an optimization function, wherein the optimization function is configured to minimize a number of the set of layers while complying with layer collision constraints, the plurality of gate operations comprises at least a first gate operation, a second gate operation and a third gate operation, the set of layers comprises at least a first layer, a second layer and a third layer, whereby said allocating comprises designating the first gate operation to the first layer, designating the second gate operation to the second layer, and designating the third gate operation to the third layer, wherein the logical representation indicates that the first gate operation is applied on first and second logical qubits of the plurality of logical qubits, wherein said allocating comprises determining a qubit route between first and second qubit patches of the plurality of qubit patches, the first and second qubit patches representing the first and second logical qubits, respectively, wherein said allocating comprises designating the qubit route to the first layer; and
synthesizing the quantum circuit according to the set of layers, whereby a synthesized quantum circuit is optimized according to the optimization function.

2. The method of claim 1, wherein the layer collision constraints define that qubit routes for implementing the plurality of gate operations between the plurality of patches cannot collide within a same layer, whereby the qubit route does not collide with any other qubit route within the first layer.

3. The method of claim 1, wherein said obtaining the physical representation comprises generating the physical representation based on precedence constraints of the logical representation and based on the optimization function.

4. The method of claim 3, wherein said generating the physical representation comprises selecting, for each logical qubit of the plurality of logical qubits, a patch from the plurality of qubit patches for representing the each logical qubit.

5. The method of claim 4, wherein said generating the physical representation comprises selecting for the first and second logical qubits a single patch from the plurality of qubit patches for representing the first and second logical qubits.

6. The method of claim 3, wherein said generating the physical representation comprises determining, for each logical qubit of the plurality of logical qubits, properties of a respective qubit patch from the plurality of qubit patches, the properties comprising at least one of: a size, a relative location in the plane, and a shape of the patch within the plane.

7. The method of claim 3, wherein said generating the physical representation comprises determining to dynamically adjust a property at least one patch from the plurality of patches during an execution of the synthesized quantum circuit on the quantum computer.

8. The method of claim 7, wherein the property comprising at least one of: a size of the at least one patch, a relative location of the at least one patch in the plane, and a shape of the at least one patch within the plane.

9. The method of claim 8, wherein the property comprises the size of the at least one patch, wherein the size of the at least one patch is selected such that a number of physical qubits that constitute the at least one patch is greater than a number of the logical qubits represented by the at least one patch.

10. The method of claim 7, wherein said dynamically adjusting the property of the at least one patch comprises:
determining that gate operations are applied on the first and second qubit patches a plurality of times within one or more layers that are subsequent to an intermediate layer of the plurality of layers;
determining that the qubit path between the first and second qubit patches is longer than a threshold; and
determining to dynamically adjust a relative location of the second qubit patch in the plane to a second relative location in the plane that is adjacent to the first qubit patch after the intermediate layer.

11. The method of claim 3, wherein said generating the physical representation comprises determining, for each gate operation of the plurality of gate operations that is configured to be applied on the first and second logical qubits, a respective qubit route between the first and second qubit patches.

12. The method of claim 3, wherein said generating the physical representation comprises selecting one or more relative locations in the plane and qubit routes for one or more respective T factory patches in the physical representation, wherein the plurality of patches comprises the T factory patches.

13. The method of claim 3, wherein the logical representation of the quantum circuit is implementable by a plurality of alternative physical representations of the quantum circuit, each of which implementing the logical representation in a different way, wherein said generating the physical representation comprises selecting the physical representation for the quantum circuit from the plurality of alternative physical representations based on the optimization function.

14. The method of claim 1, wherein the qubit route comprises qubits from the one or more auxiliary patches that physically connect the first and second qubit patches.

15. The method of claim 1, wherein the physical representation utilizes a surface code technique for representing the plurality of logical qubits using the plurality of qubit patches and for representing the plurality of gate operations using the one or more auxiliary patches, whereby errors of qubits in the plurality of patches are iteratively corrected every error correction layer of the surface code technique.

16. The method of claim 1, wherein the optimization function is configured to reduce at least one of: an overall error rate of the quantum circuit, a runtime of the quantum circuit, and a total number of physical qubits that is allocated to the physical representation.

17. The method of claim 16, wherein the logical representation of the quantum circuit is configured to provide an output via one or more logical output qubits, wherein the overall error rate of the quantum circuit comprises an error rate of the one or more logical output qubits.

18. The method of claim 16, wherein:
the optimization function defines a Constraint Satisfaction Problem (CSP) that corresponds to the quantum circuit, the CSP comprises variables, domains and constraints, each variable of the variables has a corresponding domain in the domains that defines one or more potential values of the variable, the constraints define one or more constraints on values of the variables or portion thereof, the constraints comprise the layer collision constraints, precedence constraints between the plurality of gate operations, collision constraints on qubit routes of a same layer, surface code constraints, and hardware constraints associated with the plane of at least two dimensions; and
the method further comprises generating the physical representation by utilizing a CSP solver to solve the CSP, wherein a solution of the CSP defines the physical representation of the quantum circuit.

19. The method of claim 18, wherein the CSP further comprise parameters defining: borders and relative locations of the plurality of qubit patches within the plane, borders and relative locations of the one or more auxiliary patches within the plane, and a mapping of the plurality of logical qubits to the plurality of patches.

20. The method of claim 1, wherein the plurality of qubit patches is configured to represent the plurality of logical qubits, wherein the one or more auxiliary patches are configured to represent an auxiliary region for applying the plurality of gate operations between at least a subset of the plurality of qubit patches, the auxiliary region comprising qubit routes between the subset of the plurality of qubit patches.

21. The method of claim 1, wherein the logical representation of the quantum circuit comprises a Directed Acyclic Graph (DAG), wherein nodes of the DAG represent the plurality of gate operations, wherein edges between the nodes represent precedence constraints between the plurality of gate operations.

22. The method of claim 1, wherein the plane of at least two dimensions comprises a mapping of physical connectivity links between each two physical qubits of the set of physical qubits, wherein the each two physical qubits of the set of physical qubits are either connected or not connected.

23. An apparatus comprising a processor and coupled memory, said processor being adapted to:
obtain a logical representation of a quantum circuit, wherein the logical representation comprises a plurality of logical qubits, wherein the logical representation defines a plurality of gate operations on subsets of the plurality of logical qubits;
obtain a physical representation of the quantum circuit on a quantum computer, the quantum computer comprising a set of physical qubits positioned on a plane embedded in at least two dimensions, the physical representation comprising:
a division of the set of physical qubits into a plurality of patches, the plurality of patches comprising a plurality of qubit patches and one or more auxiliary patches, wherein no qubit in the set of physical qubits belongs to more than one patch of the plurality of patches; and
a mapping of the plurality of logical qubits to the plurality of qubit patches;
allocate the plurality of gate operations to a set of layers, whereby determining a reduced number of layers for the quantum circuit, wherein said allocate is performed based on the physical representation and based on an optimization function, wherein the optimization function is configured to minimize a number of the set of layers while complying with layer collision constraints, the plurality of gate operations comprises at least a first gate operation, a second gate operation and a third gate operation, the set of layers comprises at least a first layer, a second layer and a third layer, whereby said allocate comprises designating the first gate operation to the first layer, designating the second gate operation to the second layer, and designating the third gate operation to the third layer, wherein the logical representation indicates that the first gate operation is applied on first and second logical qubits of the plurality of logical qubits, wherein said allocate comprises determining a qubit route between first and second qubit patches of the plurality of qubit patches, the first and second qubit patches representing the first and second logical qubits, respectively, wherein said allocate comprises designating the qubit route to the first layer; and
synthesize the quantum circuit according to the set of layers, whereby a synthesized quantum circuit is optimized according to the optimization function.

24. The apparatus of claim 23, wherein the plurality of patches comprises a respective plurality of groups of physical qubits from the set of physical qubits, wherein each group of the plurality of groups comprises connected physical qubits, wherein no patch of the plurality of patches comprises a physical qubit that is not physically connected to any other physical qubit in the patch.

25. A computer program product comprising a non-transitory computer readable medium retaining program instructions, which program instructions when read by a processor, cause the processor to:
obtain a logical representation of a quantum circuit, wherein the logical representation comprises a plurality of logical qubits, wherein the logical representation defines a plurality of gate operations on subsets of the plurality of logical qubits;
obtain a physical representation of the quantum circuit on a quantum computer, the quantum computer comprising a set of physical qubits positioned on a plane embedded in at least two dimensions, the physical representation comprising:
a division of the set of physical qubits into a plurality of patches, the plurality of patches comprising a plurality of qubit patches and one or more auxiliary patches, wherein no qubit in the set of physical qubits belongs to more than one patch of the plurality of patches; and
a mapping of the plurality of logical qubits to the plurality of qubit patches;
allocate the plurality of gate operations to a set of layers, whereby determining a reduced number of layers for the quantum circuit, wherein said allocate is performed based on the physical representation and based on an optimization function, wherein the optimization function is configured to minimize a number of the set of layers while complying with layer collision constraints, the plurality of gate operations comprises at least a first gate operation, a second gate operation and a third gate operation, the set of layers comprises at least a first layer, a second layer and a third layer, whereby said allocate comprises designating the first gate operation to the first layer, designating the second gate operation to the second layer, and designating the third gate operation to the third layer, wherein the logical representation indicates that the first gate operation is applied on first and second logical qubits of the plurality of logical qubits, wherein said allocate comprises determining a qubit route between first and second qubit patches of the plurality of qubit patches, the first and second qubit patches representing the first and second logical qubits, respectively, wherein said allocate comprises designating the qubit route to the first layer; and
synthesize the quantum circuit according to the set of layers, whereby a synthesized quantum circuit is optimized according to the optimization function.
